(19) United States
(12) Patent Application Publication
(10) Pub. No.: US 2009/0261289 A1
(43) Pub. Date: Oct. 22, 2009

(54) R502, R12 or R22 Substitute Mixed Refrigerant and Refrigeration System Using Thereof

(76) Inventors: Yoon-Sik Ham, Seoul (KR); Haimi Jung, Baltimore, MD (US)

Correspondence Address: PARK LAW FIRM, 3255 WILSHIRE BLVD, SUITE 1110, LOS ANGELES, CA, 90010, US

(21) Appl. No.: 11/574,202

(22) PCT Filed: Aug. 17, 2005
(86) PCT No.: PCT/KR2005/002678

§ 371 Date: Feb. 23, 2007

(30) Foreign Application Priority Data
Aug. 25, 2004 (KR) 10-2004-0066982
Aug. 25, 2004 (KR) 10-2004-0066983
Aug. 25, 2004 (KR) 10-2004-0066984
Aug. 25, 2004 (KR) 10-2004-0066985
Aug. 25, 2004 (KR) 10-2004-0066986
Aug. 25, 2004 (KR) 10-2004-0066987
Aug. 25, 2004 (KR) 10-2004-0066988
Aug. 25, 2004 (KR) 10-2004-0066989
Aug. 25, 2004 (KR) 10-2004-0066990
Aug. 25, 2004 (KR) 10-2004-0066992
Jun. 27, 2005 (KR) 10-2005-0055471

(51) Int. Cl. C09K 5/00

(52) U.S. Cl. 252/67

(57) ABSTRACT

The present invention relates to a refrigerant mixture for substituting R502, R22 or R12 used in a vapor compression refrigerator or air conditioner and a refrigeration system using the same. More specifically, the present invention relates to a refrigerant mixture comprising a combination of two or three components, which is capable of being used without causing ozone layer destruction and global warming and at the same time, without replacement of the existing refrigeration system, wherein the components are selected from the group consisting of propylene, propane, 1,1,1,2-tetrafluoroethane, pentafluoroe thane, 1,1,1-trifluoroethane, 1,1-difluoroethane, dimethylether and isobutane; and a refrigeration system using the same.

### TECHNICAL FIELD

The present invention relates to a refrigerant mixture for substituting R502, R22 or R12 used in a vapor compression refrigerator or air conditioner and a refrigeration system using the same. More specifically, the present invention relates to a refrigerant mixture comprising a combination of two or three components, which is capable of being used without causing ozone layer destruction and global warming and at the same time, without replacement of the existing refrigeration system, wherein the components are selected from the group consisting of propylene, propane, 1,1,1,2-tetrafluoroethane, pentafluoroethane, 1,1,1-trifluoroethane, 1,1-difluoroethane, dimethylether and isobutane; and a refrigeration system using the same.

### BACKGROUND ART

The present invention relates to a refrigerant mixture comprising a selective combination of propylene, propane and R134a, these being materials that can be used as a refrigerant (hereinafter, referred to as ‘R’) in vapor compression refrigerators/air conditioners, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, also referred to as R22 or HCFC22) which has been widely used in household and commercial air conditioners, and a refrigeration system using the same.

Further, the present invention relates to a refrigerant mixture comprising a selective combination of propylene, propane, R125 and R143a, and a refrigeration system using the same. More specifically, the present invention relates to a refrigerant mixture capable of substituting R502 (hereinafter, also referred to as CFC502) which has been widely used in freezers for low temperature service and refrigerators for transportation service.

Further, the present invention relates to a refrigerant mixture comprising a selective combination of propylene, propane, R152a, dimethylether (hereinafter, referred to as DME) and isobutane, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, referred to as R22 or HCFC22) which has been widely used in household and commercial air conditioners, and a refrigeration system using the same.

In addition, the present invention relates to a refrigerant mixture comprising a selective combination of propylene, R134a, R152a, dimethylether (hereinafter, referred to as DME) and isobutane, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, also referred to as R22 or HCFC22) which has been widely used in household and commercial air conditioners, and a refrigeration system using the same.

Still further, the present invention relates to a refrigerant mixture comprising a selective combination of propylene, R152a, dimethylether (hereinafter, referred to as DME) and isobutane, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, also referred to as R22 or HCFC22) which has been widely used in household and commercial air conditioners, and a refrigeration system using the same.

Still further, the present invention relates to a refrigerant mixture comprising a selective combination of propane, 1,1,1,2-tetrafluoroethane and 1,1-difluoroethane, and a refrigeration system using the same. More specifically, the present invention relates to a refrigerant mixture capable of substituting monochlorofluoromethane (CHClF₂, hereinafter, also referred to as R22 or HCFC22) which has been widely used in household and commercial air conditioners, and a refrigeration system using the same.

Still further, the present invention relates to a refrigerant mixture comprising a selective combination of propane, 1,1,1,2-tetrafluoroethane, dimethylether (hereinafter, referred to as DME) and isobutane, and a refrigeration system using the same. More specifically, the present invention relates to a refrigerant mixture capable of substituting dichlorodifluoromethane (CCl₂F₂, hereinafter, also referred to as R12 or CFC12) which has been widely used in household refrigerators and vehicle air conditioners and monochlorofluoromethane (CHClF₂, hereinafter, also referred to as R22 or HCFC22) which has been widely used in household and commercial air conditioners and a refrigeration system using the same.

Still further, the present invention relates to a refrigerant mixture comprising a selective combination of propane, 1,1-difluoroethane, dimethylether (hereinafter, referred to as DME) and isobutane, and a refrigeration system using the same. More specifically, the present invention relates to a refrigerant mixture capable of substituting dichlorodifluoromethane (CCl₂F₂, hereinafter, also referred to as R12 or CFC12) which has been widely used in household refrigerators and vehicle air conditioners and monochlorofluoromethane (CHClF₂, hereinafter, referred to as R22 or HCFC22) which has been widely used in household and commercial air conditioners and a refrigeration system using the same.

Still further, the present invention relates to a refrigerant mixture comprising a selective combination of R134a, R152a and dimethylether (hereinafter, referred to as DME), and a refrigeration system using the same. More specifically, the present invention relates to a refrigerant mixture capable of substituting dichlorodifluoromethane (CCl₂F₂, hereinafter, referred to as R12 or CFC12) which has been widely used in household refrigerators and vehicle air conditioners and a refrigeration system using the same.

Still further, the present invention relates to a refrigerant mixture comprising a selective combination of 1,1,1,2-tetrafluoroethane, 1,1-difluoroethane, dimethylether (hereinafter, referred to as DME) and isobutane, and a refrigeration system using the same. More specifically, the present invention relates to a refrigerant mixture capable of substituting dichlorodifluoromethane (CCl₂F₂, hereinafter, referred to as R12 or CFC12) which has been widely used in household refrigerators and vehicle air conditioners and a refrigeration system using the same.

CFC502 is an azeotropic refrigerant mixture composed of 48.8% monochlorofluoromethane (hereinafter, referred to as R22 or HCFC22) and 51.2% chloropentafluoroethane (hereinafter, referred to as R115 or CFC115).

As the refrigerant for use in refrigerators, air conditioners and heat pumps, chlorofluorocarbon (hereinafter, referred to as CFC) and hydrochlorofluorocarbon (hereinafter, referred to as HCFC) derived from methane or ethane have been primarily used. In particular, as the refrigerant for use in freezers for low temperature service, refrigerators for transportation service, and supermarket refrigerators, CFC502 having a boiling point of −45.4° C. and a molecular mass of 111.6 kg/kmol has been most widely used. HCFC22 having a boiling point of −40.8° C. and a molecular mass of 86.47 kg/kmol has been most widely used in household air conditioners and commercial air conditioners. In particular, CFC12 having a boiling point of −29.75° C. and a molecular mass of 120.93 kg/kmol has been most widely used in household refrigerators and vehicle air conditioners.

However, destruction of an ozone layer or ozonosphere, a part of the Earth's stratosphere, caused by CFC and HCFC, has recently become an important global environmental concern. As a result, production and use of CFC and HCFC causing depletion of ozone in the stratosphere are regulated by the Montreal Protocol adopted in 1987. CFC502 and HCFC22 have high ozone depletion potentials (hereinafter, referred to as ODP) of 0.18 and 0.05, respectively, and thus production and use thereof have been or will be completely abolished in advanced countries pursuant to the Montreal Protocol. Therefore, most countries around the world are planning to use an alternative refrigerant having an ODP of 0.0.

Recently, in addition to problems associated with ozonosphere destruction, global warming concerns have raised a great deal of attention and the Kyoto Protocol ratified in 1997 strongly recommends restrained use of HFC refrigerants having a high global warming potential (hereinafter, referred to as GWP). In compliance with such a trend, European and Japanese refrigerator manufacturing companies use a hydrocarbon refrigerant, i.e., isobutane (hereinafter, referred to as R600a) in most refrigerators, and manufacturing companies of household air conditioners, heat pumps, freezers for low temperature service and vehicle air conditioners are also finding uses for hydrocarbon-based refrigerants having a low GWP.

Table 1 below exemplifies environmental indices of several refrigerants. As can be seen from Table 1, propylene, propane, isobutane, DME and HFC152a exhibit an ozone depletion potential (ODP) of 0.0 and also have a significantly low global warming potential (GWP) as compared to the remaining other refrigerants. Due to such properties, European Union (EU), Japan and most Asian countries have made many attempts to achieve desired thermodynamic properties and at the same time, to enhance efficiency and compatibility with oil via combination of refrigerants having an ODP of 0.0 and a lower GWP than conventional CFC or HFC refrigerants. From that point of view, propylene, propane, isobutane, DME and HFC152a can be said to be competent for such a purpose.

TABLE 1

| Refrigerants | (ODP) | (GWP) |
|---|---|---|
| CFC12 | 0.9 | 8,500 |
| HFC134a | 0.0 | 1,300 |
| HCFC22 | 0.05 | 1,700 |
| R407C | 0.0 | 1,370 |
| CFC502 | 0.18 | 4,510 |
| R404A | 0.0 | 3,850 |
| HFC125 | 0.0 | 3,200 |
| HFC143a | 0.0 | 4,400 |
| HFC152a | 0.0 | 140 |
| Propylene (R1270) | 0.0 | Below 3 |
| Propane (R290) | 0.0 | Below 3 |
| DME (RE170) | 0.0 | Below 3 |
| Isobutane (R600a) | 0.0 | Below 3 |

ODP is set on the basis of CFC-11 = 1.0.
GWP is set on the basis of CO₂ = 1.0 (100 yr. time horizon).

In order to ensure that a certain material is to be useful as an alternative refrigerant for the existing refrigerant, first of all, that material should have a coefficient of performance (hereinafter, referred to as COP) similar to that of the existing refrigerant. As used herein, the term “coefficient of performance (COP) refers to a ratio of total refrigeration effects of a system versus the amount of work put in to a compressor. Therefore, the higher COP provides higher energy efficiency of the refrigerator/air conditioner. In addition, if it is desired to use the compressor without significant modification, an alternative refrigerant should have vapor pressure similar to the conventional refrigerant, finally providing a similar volumetric capacity (hereinafter, referred to as VC). As used herein, the term volumetric capacity (VC) means refrigeration effects per unit volume and is a factor representing a size of the compressor. VC is generally proportional to vapor pressure and is expressed in a unit of kJ/m³. If the alternative refrigerant provides the volumetric capacity comparable to the existing refrigerants, it is highly advantageous in that manufacturing companies can construct the refrigerator/air conditioner without replacement or significant modification of the compressor. However, the results of research and study performed hitherto have revealed that replacement of the existing refrigerant with a pure material raises a need for replacement or significant modification of the compressor due to difference in volumetric capacity between the alternative refrigerant and conventional refrigerant and it is also difficult to achieve the coefficient of performance (COP) comparable to that of the conventional refrigerant.

One of the methods capable of solving such problems is use of a refrigerant mixture. The refrigerant mixture is advantageous in that the composition thereof can be adjusted by suitably combining components to simultaneously obtain the coefficient of performance and volumetric capacity (VC) to be comparable to those of the existing refrigerant, thereby rendering it unnecessary to significantly modify the compressor. Due to such properties, a variety of refrigerant mixtures as an alternative to CFC502 or HCFC22 have been proposed over past several years, but some of them contain HCFC as a constituent, use of which is prohibited pursuant to the Montreal Protocol. Therefore, such refrigerant mixtures containing HCFC are not suitable alternative refrigerants from the standpoint of a long-term view.

EI DuPont de Nemours & Co., a US company, has developed R404A, a ternary refrigerant mixture composed of 44% R125, 52% R143a and 4% R134a, but has a lower energy efficiency than R502, thereby probably being indirectly capable of causing global warming. Further, R404A consists of only HFC, use of which is restricted pursuant to the Kyoto Protocol, and thus is not suitable as the alternative refrigerant from the standpoint of a long-term view. In addition, DuPont has developed and sold ternary refrigerant mixtures composed of HCFC and hydrofluorocarbon (hereinafter, referred to as HFC), such as MP39 composed of 53% R22, 34% R124 and 13% R152a and MP66 composed of 61% R22, 28% R124 and 11% R152a. Further, Monroe Air Tech Inc. has developed and sold a ternary refrigerant mixture composed of HCFC and isobutane, called GHG-X3 composed of 65% R22, 4% R600a and 31% R142b, and many other companies are also planning to develop and commercialize a variety of refrigerant mixtures. However, most of such refrigerants exhibit an ODP higher than 0.0, thus being detrimental to the environment, and have lower energy efficiency than CFC12, thus probably accelerating indirect effects of global warming. In addition, as such refrigerants consist of HCFC and HFC, use of which is restricted pursuant to the Kyoto Protocol, they are unsuitable as alternative refrigerants from the standpoint of a long-term view.

R407C, a ternary refrigerant mixture composed of 23% R32, 25% R125 and 52% R134a, which was developed by DuPont, has a refrigeration capacity similar to that of the conventional HCFC22 refrigerant, but has relatively low energy efficiency and a gliding temperature difference of 7° C., thus suffering from disadvantage of compositional separation of the refrigerant when leakage of refrigerant occurs in the refrigeration system. In addition, where the gliding temperature difference is too large, a phase change of the refrigerant results in continuous variation of pressure in the evaporator and condenser, thus causing instability of the refrigeration system. Meanwhile, Allied Signal Inc. has developed and sold R410A, a binary refrigerant mixture composed of 50% R32 and 50% R125. This refrigerant, however, suffered from disadvantages such as a need for modification of the compressor due to vapor pressure 60% higher than the conventional HCFC22 and a need to increase strength of a material constituting the condenser due to high system pressure.

### DISCLOSURE OF INVENTION

### Technical Problem

Therefore, the present invention has been made in view of the above problems, and it is an object of the present invention to develop a novel refrigerant mixture which can be used without replacement of the existing refrigeration system while at the same time, without causing ozonosphere depletion and global warming, in order to alleviate adverse effects of R502, R22 and R12, which have been conventionally used in a vapor compression refrigerator or air conditioner, on ozonosphere depletion and global warming.

### Technical Solution

In accordance with an aspect of the present invention, the above and other objects can be accomplished by a refrigerant mixture comprising combination of two or three components selected from the group consisting of propylene, propane, 1,1,1,2-tetrafluoroethane, pentafluoroethane, 1,1,1-trifluoroethane, 1,1-difluoroethane, dimethylether and isobutane, in order to provide a novel refrigerant which can be used without replacement of the existing refrigeration system while at the same time, without causing ozonosphere depletion and global warming.

### ADVANTAGEOUS EFFECTS

A refrigerant mixture in accordance with preferred embodiment of the present invention as constructed above, substituting R502, R12 or R22, and a refrigeration system using the same, employ propylene, propane, 1,1,1,2-tetrafluoroethane, pentafluoroethane, 1,1,1-trifluoroethane, 1,1-difluoroethane, dimethylether (DME) and isobutene as ingredients of the refrigerant, each having an ozone depletion potential (ODP) of 0.0 and a very low global warming potential (GWP), and thus provide pronounced effects capable of preventing ozonosphere destruction and global warming even in case of leakage or disposal of refrigerants.

In addition, the refrigerant mixture in accordance with the present invention can be directly applied without replacement of the compressor or without modification of the existing refrigeration system and thus reduces time and costs of adoption, by mixing propylene, propane, 1,1,1,2-tetrafluoroethane, pentafluoroethane, 1,1,1-trifluoroethane, 1,1-difluoroethane, dimethylether and isobutane in a suitable composition ratio such that vapor pressure or volumetric capacity of the refrigerant mixture is similar to that of the conventionally used refrigerant, i.e., R502, R12 or R22.

Further, as the refrigerant mixture in accordance with the present invention accomplishes a small gliding temperature difference by mixing refrigerant components in a suitable composition ratio, the refrigeration system can be stably used with substantially no change in pressure of the refrigerant due to a phase change thereof, and compositional separation upon leakage of refrigerant is prevented.

Further, a refrigerant mixture composed of R152a and DME in accordance with one embodiment of the present invention contains a large proportion of DME having excellent compatibility with refrigerator oil thus leading to excellent compatibility of the refrigerant mixture, and employs more than 70% by weight of DME leading to reduction in production costs which advantageously facilitates use of an environmentally friendly refrigerant mixture.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a block diagram of a conventional refrigerator/air conditioner used in the present invention. Herein, Qc represents the heat flow direction in a condenser (refrigerant->air); Qe represents the heat flow direction in an evaporator (air->refrigerant); TS1 represents a temperature at an air inlet of the evaporator; TS7 represents a temperature at an air outlet of the evaporator; TS3 represents a temperature at an air outlet of the condenser; and TS6 represents a temperature at an air inlet of the condenser.

### BEST MODE FOR CARRYING OUT THE INVENTION

Hereinafter, a refrigerant mixture alternative to R502 and R22 in accordance with a first embodiment of the present invention and construction of a refrigeration system using the same will be described in more detail with reference to the accompanying drawings.

The present invention relates to a refrigerant mixture comprising a selective combination of propylene, propane and R134a, these being materials that can be used as a refrigerant (hereinafter, referred to as “R”) in vapor compression refrigerators/air conditioners, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, referred to as R22 or HCFC22) which has been widely used in household and commercial air conditioners, and a refrigeration system using the same.

The object of the present invention is to provide a refrigerant mixture which has an ozone depletion potential (ODP) of 0.0 with no effects on the ozonosphere and a lower global warming potential (GWP) than conventional other alternative refrigerants and at the same time, can be used as the alternative refrigerant to CFC502 and HCFC22 without significant modification of the existing compressor, and a refrigeration system using the same.

More particularly, the present invention relates to an alternative refrigerant mixture comprising a selective combination of R1270 (propylene), R290 (propane) and R134a (1,1,1,2-tetrafluoroethane). The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC502 or HCFC22.

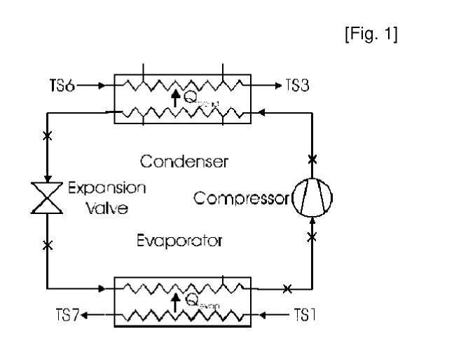

FIG. 1 is a block diagram of a conventional refrigerator/air conditioner utilized in the present invention. As shown in FIG. 1, the refrigerator/air conditioner generally includes an evaporator, a condenser, a compressor and an expansion valve.

In order to develop the alternative refrigerant mixture, the present inventors employed a CYCLE-D program, simulating performance of the refrigerator/air conditioner and developed by the National Institute of Standards and Technology. Using such a program, thermodynamic and heat transfer analysis were carried out on constitutional components of the refrigerator/air conditioner, for example a heat exchanger and compressor and the analysis results were combined together for use. One of the important factors determining accuracy of the program is physical properties of the refrigerants. In this program, physical properties of all refrigerants were calculated using a Carnahan-Starling-De Santis (CSD) equation of state which is adopted as a standard in USA and Japan. The CSD equation of state, known as REFPROP, is a program developed by the National Institute of Standards and Technology and most widely used in eminent enterprises, institutes and universities around the world, related to refrigeration/air conditioning technology, due to verification of accuracy and applicability thereof. As input data for use in development and implementation of the refrigerant mixture of the present invention and the refrigerator/air conditioner, practical data was used as much as possible.

Under the criteria that the ozone depletion potential (ODP) of an alternative refrigerant for the refrigerator/air conditioner must be 0.0 and the global warming potential (GWP) thereof should be minimized to the maximum extent possible, the refrigerant mixture of the present invention employed a selective combination of natural refrigerants R1270 (propylene), R290 (propane) and R134a (1,1,1,2-tetrafluoroethane), which enables replacement of conventional refrigerants.

Table 2 below shows the results of comparison on coefficients of performance (COP) between the refrigerant mixtures of the present invention and conventional refrigerants, calculated using a computer interpretation program via application of working conditions of the refrigerator/air conditioner utilizing conventional CFC502. Table 3 below shows the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 2
Comparison of performance between CFC502 and alternative refrigerant mixtures

| | Composition (wt %) | | | | | GTD | | COP_{diff} | VC_{diff} |
|---|---|---|---|---|---|---|---|---|---|
| Refrigerants | R1270 | R290 | R134a | COP | VC(kJ/m³) | (° C.) | T_{dis}(° C.) | (%) | (%) |
| CFC502 | | | | 1.07 | 816 | 0.2 | 102.2 | | |
| R404A | | | | 0.99 | 807 | 0.7 | 94.7 | −7.5 | −1.1 |
| EX. A1 | 10 | 90 | | 1.17 | 767 | 0.4 | 102.2 | 9.3 | −6.0 |
| EX. A2 | 30 | 70 | | 1.20 | 841 | 0.6 | 103.9 | 12.1 | 3.1 |
| EX. A3 | 70 | 30 | | 1.23 | 945 | 0.1 | 108.1 | 15.0 | 15.8 |
| EX. A4 | 30 | | 70 | 1.27 | 794 | 6.3 | 109.9 | 18.7 | −2.7 |
| EX. A5 | 50 | | 50 | 1.27 | 914 | 1.3 | 109.4 | 18.7 | 12.0 |
| EX. A6 | 90 | | 10 | 1.24 | 976 | 0.0 | 111.6 | 15.9 | 19.6 |
| EX. A7 | 10 | 80 | 10 | 1.21 | 829 | 2.0 | 101.5 | 13.1 | 1.6 |
| EX. A8 | 15 | 80 | 5 | 1.20 | 817 | 1.3 | 102.3 | 12.1 | 0.1 |
| EX. A9 | 30 | 60 | 10 | 1.23 | 897 | 1.2 | 103.3 | 15.0 | 9.9 |

TABLE 3
Comparison of performance between HCFC22 and refrigerant mixtures of the present
invention

| | Composition (wt %) | | | | | GTD | | COP_{diff} | VC_{diff} |
|---|---|---|---|---|---|---|---|---|---|
| Refrigerants | R1270 | R290 | R134a | COP | VC(kJ/m³) | (° C.) | T_{dis}(° C.) | (%) | (%) |
| HCFC22 | | | | 2.88 | 3565 | 0.0 | 98.2 | | |
| R407C | | | | 2.79 | 3776 | 6.9 | 90.6 | −3.1 | 5.9 |
| EX. A10 | 20 | 80 | | 2.58 | 3200 | 0.6 | 81.5 | −10.4 | −10.2 |
| Ex. A11 | 50 | 50 | | 2.61 | 3464 | 0.3 | 82.9 | −9.4 | −2.8 |
| Ex. A12 | 70 | 30 | | 2.62 | 3575 | 0.1 | 83.9 | −9.0 | 0.3 |
| Ex. A13 | 90 | 10 | | 2.62 | 3631 | 0.0 | 85.2 | −9.0 | 1.9 |
| Ex. A14 | 40 | | 60 | 2.74 | 3597 | 3.5 | 84.3 | −4.9 | 0.9 |
| Ex. A15 | 60 | | 40 | 2.69 | 3709 | 0.4 | 84.4 | −6.6 | 4.0 |
| Ex. A16 | 90 | | 10 | 2.64 | 3674 | 0.0 | 85.4 | −8.3 | 3.1 |
| Ex. A17 | 40 | 50 | 10 | 2.64 | 3559 | 0.8 | 82.3 | −8.3 | −0.2 |
| Ex. A18 | 50 | 40 | 10 | 2.64 | 3614 | 0.5 | 82.7 | −8.3 | 1.4 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC502 (Table 2) and versus HCFC22 (Table 3), respectively
VC_{diff}: Difference in volumetric capacity versus CFC502 (Table 2) and versus HCFC22 (Table 3), respectively

It can be seen from Table 2 that refrigerant mixtures of Examples A1 through A9 in accordance with the present invention, alternative to CFC502, exhibit coefficients of performance (COP) equal to or higher than that of conventional CFC502 or R404A and a volumetric capacity similar to CFC502 or R404A.

From the results of Table 3, it can be seen that alternative refrigerant mixtures of Examples A10 through A18, substituting HCFC22, exhibit a slightly lower coefficient of performance (COP) than HCFC22 or R407 but a similar volumetric capacity. In particular, refrigerant mixtures, substituting for HCFC22, exhibit a compressor discharge temperature 15° C. lower than HCFC22, and are primarily based on hydrocarbon, resulting in excellent compatibility with oil which enables provision of superior performance to HCFC22 in practical application thereof to refrigerators. In addition, all of such refrigerant mixtures except one exhibit a gliding temperature difference of less than 2° C. and are therefore near-azeotropic. Considering that currently commercially available refrigerant mixtures usually have a gliding temperature difference of less than 7° C., the above-mentioned refrigerant mixtures of the present invention have no problems associated with use thereof.

All refrigerants of inventive Examples A1 through A18 have an ozone depletion potential (ODP) of 0.0, causing no ozonosphere depletion, and thus are also far more environmentally friendly than CFC502 or HCFC22. Further, since R404A or R407C, an alternative refrigerant to CFC502 and HCFC22, exhibits a high global warming potential (GWP) and therefore use thereof is regulated pursuant to the Kyoto Protocol, preparation of the refrigerant mixture utilizing propylene and propane as main ingredients reduces an amount of HFC to be used, thereby alleviating global warming.

For reference, refrigerants having other compositions outside the composition range of the above-mentioned Examples in accordance with the present invention suffer from a problem such as excessively large gliding temperature difference, excessively low capacity and efficiency, or excessively high compressor discharge temperature, thereby raising problems in practical application thereof to refrigerators/air conditioners. Hereinafter, details thereof will be reviewed.

### Examples A1 through A3

As shown in Examples A1, A2 and A3 in accordance with the present invention, refrigerant mixtures composed of R1270 and R290 exhibit increases in a volumetric capacity thereof and increases in compressor discharge temperatures as a content of R1270 increases. Therefore, in order to secure the volumetric capacity similar to that of a conventional refrigerant, it is preferred that a content of R1270 in the refrigerant mixture does not exceed 55% by weight.

As shown in Table 2, the refrigerant mixture of Example A2 comprising 30% by weight of R1270 exhibited a volumetric capacity of 841 kJ/m³, while the refrigerant mixture of Example A3 comprising 70% by weight of R1270 exhibited a volumetric capacity of 945 kJ/m³. In this manner, inclusion of more than 70% by weight of R1270 in the refrigerant mixture results in an excessively large volumetric capacity as compared to 807 kJ/m³ of the conventional refrigerant, R404A, thus requires replacement of the existing refrigeration system including a compressor. Therefore, R1270 is preferably contained in an amount of less than 55% by weight so as to achieve the volumetric capacity similar to that of the conventional refrigerant.

Table 4 below shows the results of comparison on coefficients of performance between a refrigerant mixture of R1270 and R290 and a conventional refrigerant, calculated using a computer interpretation program under working conditions of the refrigerator/air conditioner using conventional CFC502. As shown in Table 4, where the content of R1270 exceeds 60% by weight, the refrigerant mixture of R1270 and R290 exhibited a significant difference in volumetric capacity upon comparing with the conventional refrigerants R502 and R404A.

TABLE 4
Performance of refrigerant mixtures having various compositions in the refrigerator/air
conditioner using CFC502

| | Composition (wt %) | | | | | GTD | | COP_{diff} | VC_{diff} |
|---|---|---|---|---|---|---|---|---|---|
| Refrigerants | R1270 | R290 | R134a | COP | VC(kJ/m³) | (° C.) | T_{dis}(° C.) | (%) | (%) |

| | | | | | | |
|---|---|---|---|---|---|---|
| R502 | | | 1.07 | 816 | 0.2 | 102.7 |
| R404A | | | 0.99 | 807 | 0.7 | 94.7 |
| Comp. | 10 | 90 | 1.17 | 766 | 0.4 | 102 |
| Ex. 1 | | | | | | |
| Comp. | 20 | 80 | 1.19 | 805 | 0.6 | 103 |
| Ex. 2 | | | | | | |
| Comp. | 30 | 70 | 1.20 | 841 | 0.6 | 104 |
| Ex. 3 | | | | | | |
| Comp. | 40 | 60 | 1.21 | 873 | 0.5 | 105 |
| Ex. 4 | | | | | | |
| Comp. | 50 | 50 | 1.22 | 901 | 0.4 | 106 |
| Ex. 5 | | | | | | |
| Comp. | 60 | 40 | 1.22 | 925 | 0.2 | 107 |
| Ex. 6 | | | | | | |
| Comp. | 70 | 30 | 1.23 | 945 | 0.1 | 108 |
| Ex. 7 | | | | | | |
| Comp. | 80 | 20 | 1.23 | 959 | 0.04 | 109 |
| Ex. 8 | | | | | | |
| Comp. | 90 | 10 | 1.23 | 969 | 0.01 | 111 |
| Ex. 9 | | | | | | |

### Examples A4 through A6

As shown in Examples A4, A5 and A6 in accordance with the present invention, refrigerant mixtures composed of R1270 and R134a exhibit increases in gliding temperature differences and decreases in volumetric capacities thereof as a content of R1270 decreases and a content of R134a increases. Therefore, in order to achieve the volumetric capacity similar to that of a conventional refrigerant, and in order to minimize gliding temperature differences to the maximum extent possible, it is preferred that a content of R1270 in the refrigerant mixture exceeds 30% by weight and a content of R134a does not exceed 70% by weight.

That is, when R134a is contained in an amount of 10% by weight, 50% by weight and 70% by weight, respectively, a gliding temperature difference has increased to 0.0° C., 1.3° C. and 6.3° C., respectively. Therefore, the refrigerant mixture containing more than 70% by weight of R134a exhibits an excessively large gliding temperature difference and thus is not desirable. Where the gliding temperature difference of the refrigerant mixture is too large, pressure of the evaporator and condenser varies according to a phase change of the refrigerant mixture. This, in turn, undesirably results in instability of the refrigeration system and compositional separation when leakage of refrigerant occurs in the refrigeration system.

### Examples A7 through A9, and A17 and A18

Refrigerant mixtures of Examples A7, A8, A9, A17 and A18 in accordance with the present invention were examined with reference to Examples A4, A5, A6, A14, A15 and A16. As can be seen from the results thus obtained, when a content of R134a in the refrigerant mixture is greater than 70% by weight, a gliding temperature difference is too large and thus pressure of the evaporator and condenser continuously varies in response to a phase change of the refrigerant mixture. This, in turn, undesirably results in instability of the refrigeration system and compositional separation when leakage of refrigerant occurs in a refrigerant circulation system. A content of R134a in the refrigerant mixture is preferably less than 70% by weight.

### Examples A7 through A9

As shown in Examples A7, A8 and A9 in accordance with the present invention, where a content of R1270 in the refrigerant mixture is greater than 30% by weight, a volumetric capacity thereof is too large, thus leading to a high pressure state of a compressor. This, in turn, undesirably requires replacement of the material constituting the condenser with higher-strength material and replacement of the compressor. In addition, where a content of R134a exceeds 10% by weight, a volumetric capacity is too small and a gliding temperature difference is too large. In order to achieve the volumetric capacity of the refrigerant mixture similar to that of a conventional refrigerant under a relatively low content of R1270 and R134a, R290 is preferably contained in the range of 60 to 80% by weight.

That is, as can be seen from refrigerant mixtures of Examples A7 and A9 in accordance with the present invention, comprising 10% by weight of R134a, a volumetric capacity thereof increases from 829 kJ/m³ to 897 kJ/m³ as a content of R1270 increases from 10% by weight to 30% by weight. Upon comparing with R404A having a volumetric capacity of 807 kJ/m³, the refrigerant mixture in which a content of R1270 exceeds 30% by weight has an excessively large volumetric capacity as compared to a conventional refrigerant R404A, thus making it impossible to use the existing refrigeration system. As such, the refrigerant mixture that can be directly applied without replacement of the existing refrigeration system needs to contain less than 30% by weight of R1270.

Table 5 below shows the results of comparison on coefficients of performance between refrigerant mixtures of R1270 and R134a and conventional refrigerants, calculated using a computer interpretation program under working conditions of the refrigerator/air conditioner using conventional CFC502.

TABLE 5
Performance of refrigerant mixtures having various compositions in the refrigerator/air
conditioner using CFC502

| | Composition (wt %) | | | | | GTD | | COP_{diff} | VC_{diff} |
|---|---|---|---|---|---|---|---|---|---|
| Refrigerants | R1270 | R290 | R134a | COP | VC(kJ/m³) | (° C.) | T_{dis}(° C.) | (%) | (%) |

| | | | | | | |
|---|---|---|---|---|---|---|
| R502 | | | 1.07 | 816 | 0.2 | 102.7 |
| R404A | | | 0.99 | 807 | 0.7 | 94.7 |
| Comp. Ex. | 10 | 90 | 1.22 | 556 | 6.9 | 109.6 |
| 11 | | | | | | |
| Comp. Ex. | 20 | 80 | 1.26 | 694 | 7.4 | 110 |
| 12 | | | | | | |
| Comp. Ex. | 30 | 70 | 1.27 | 795 | 6.1 | 110 |
| 13 | | | | | | |
| Comp. Ex. | 40 | 60 | 1.27 | 865 | 4.4 | 109.6 |
| 14 | | | | | | |
| Comp. Ex. | 50 | 50 | 1.26 | 914 | 2.7 | 109.3 |
| 15 | | | | | | |
| Comp. Ex. | 60 | 40 | 1.26 | 947 | 1.4 | 109.4 |
| 16 | | | | | | |
| Comp. Ex. | 70 | 30 | 1.25 | 968 | 0.6 | 109.9 |
| 17 | | | | | | |
| Comp. Ex. | 80 | 20 | 1.24 | 975 | 0.2 | 110.6 |
| 18 | | | | | | |
| Comp. Ex. | 90 | 10 | 1.24 | 976 | 0.04 | 111.6 |
| 19 | | | | | | |

As shown in Table 5, refrigerant mixtures composed of R1270 and R134a exhibit decreases in volumetric capacities thereof and at the same time, increases in gliding temperature differences as a content of R134a increases. In addition, the refrigerant mixture of Example A7 comprising 10% by weight of R134a as shown in Table 2 exhibited a volumetric capacity of 829 kJ/m³ and a gliding temperature difference of 2° C., while R404A exhibited a volumetric capacity of 807 kJ/m³ and a gliding temperature difference of 0.7° C. Therefore, in order to have a volumetric capacity and gliding temperature difference similar to those of R404A, it is preferred that a content of R134a in the refrigerant mixture does not exceed 10% by weight.

### Examples A17 and A18

As shown in Examples A17 and A18 in accordance with the present invention, a high content of R1270 in a refrigerant mixture results in an increased volumetric capacity. Therefore, in order to achieve a proper volumetric capacity, a content of R1270 is preferably in the range of 40 to 50% by weight. In addition, as a content of R290 increases, a volumetric capacity decreases and a gliding temperature difference increases. Therefore, in order to ensure that the refrigerant mixture has a suitable volumetric capacity and a small gliding temperature difference, a content of R290 is preferably in the range of 40 to 50% by weight. R134a has a lower vapor pressure than R1270 or R290 and thus an increase in R134a results in a decreased volumetric capacity and increased gliding temperature difference of the refrigerant mixture. Therefore, a content of R134a is preferably less than 10% by weight.

In connection with the refrigerant mixtures of Examples A12 and A13 of the present invention in Table 3, where a composition ratio of R1270:R290 is 70:30 (wt %), the refrigerant has a volumetric capacity of 3575 kJ/m³ and a gliding temperature difference of 0.1° C., while, where a ratio of R1270:R290 is 90:10 (wt %), the refrigerant has a volumetric capacity of 3631 kJ/m³ and a gliding temperature difference of 0.0° C., thus representing no significant difference therebetween.

However, in the refrigerant mixtures of Examples A14 and A15 in accordance with the present invention, where a composition ratio of R1270:R134a is 60:40% (wt %), the refrigerant has a volumetric capacity of 3709 kJ/m³ and a gliding temperature difference of 0.4° C., while, where a composition ratio of R1270:R134a is 40:60(wt %), the refrigerant has a volumetric capacity of 3597 kJ/m³ and a gliding temperature difference of 3.5° C. That is, increased R134a leads to increased volumetric capacity and gliding temperature difference of the refrigerant mixture. Consequently, the refrigerant mixture of Example A18 having a volumetric capacity similar to HCFC22 and a small gliding temperature difference is a composition suitable for substituting conventional refrigerants HCFC22 and R407C, but it is impossible to use refrigeration system utilizing the above-mentioned conventional refrigerants when the content of R134a is much greater than 10% by weight.

### Examples A10 through A13

As shown in Examples A10, A11, A12 and A13 in accordance with the present invention, the refrigerant mixture exhibits an increased volumetric capacity thereof as a content of R1270 increases. Therefore, in order to obtain the volumetric capacity similar to that of a conventional refrigerant, a content of R1270 preferably exceeds 80% by weight.

### Examples A14 through A16

As shown in Examples A14, A15 and A16 in accordance with the present invention, refrigerant mixtures composed of R1270 and R134a exhibit increases in gliding temperature differences and decreases in volumetric capacities as a content of R1270 decreases and a content of R134a increases. Therefore, in order to ensure that the refrigerant mixture has a volumetric capacity similar to that of a conventional refrigerant and a small gliding temperature difference, it is preferred that a content of R1270 in the refrigerant mixture exceeds 40% by weight and a content of R134a does not exceed 60% by weight.

As used herein, the term coefrigeration system refers to refrigerators/air conditioners which are used interchangeably throughout the specification of the present invention unless otherwise particularly specified.

Hereinafter, a refrigerant mixture for substituting R502 in accordance with a second embodiment of the present invention and construction of a refrigeration system using the same will be described in more detail.

The present invention relates to a refrigerant mixture comprising a combination of propylene, propane, R125 and R143a, as materials that can be used as a refrigerant (hereinafter, referred to as “R”) in vapor compression refrigerators/air conditioners, and a refrigeration system using the same. More specifically, the present invention relates to a refrigerant mixture capable of substituting R502 (hereinafter, also referred to as CFC502) which has been widely used in freezers for low temperature service and refrigerators for transportation service.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC502 without significant modification of the existing compressor.

More particularly, the present invention relates to a refrigerant mixture comprising a selective combination of R1270 (propylene) and R290 (propane), or R125 (pentafluoroethane) and R143a (1,1,1-trifluoroethane). The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC502.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a mixture of at least two natural refrigerant materials R1270 (propylene), R290 (propane), R125 (pentafluoroethane) and R143a (1,1,1-trifluoroethane), which enables replacement of conventional refrigerants.

Table 6 below shows the results of comparison on coefficients of performance (COP) between the refrigerant mixtures of the present invention and conventional refrigerants, calculated using a computer interpretation program via application of working conditions of the refrigerator/air conditioner utilizing conventional CFC502.

TABLE 6
Comparison of performance between CFC502 and the alternative refrigerant mixtures

| | Composition (wt %) | | | | | | GTD | | COP_{diff} | VC_{diff} |
|---|---|---|---|---|---|---|---|---|---|---|
| Refrigerants | R1270 | R290 | R125 | R143a | COP | VC(kJ/m³) | (° C.) | T_{dis}(° C.) | (%) | (%) |
| CFC502 | | | | | 1.07 | 816 | 0.2 | 102.7 | | |
| R404A | | | | | 0.99 | 807 | 0.7 | 94.7 | −7.5 | −1.1 |
| Ex. B1 | 10 | 60 | 30 | | 1.18 | 879 | 6.5 | 98.9 | 10.3 | 7.7 |
| Ex. B2 | 10 | 85 | 5 | | 1.18 | 784 | 2.2 | 101.8 | 10.3 | −3.9 |
| Ex. B3 | 20 | 70 | 10 | | 1.19 | 842 | 3.1 | 102.1 | 11.2 | 3.2 |
| Ex. B4 | 10 | 70 | | 20 | 1.23 | 927 | 1.9 | 101.5 | 15.0 | 13.6 |
| Ex. B5 | 10 | 85 | | 5 | 1.19 | 805 | 0.9 | 102.1 | 11.2 | −1.3 |
| Ex. B6 | 20 | 70 | | 10 | 1.22 | 884 | 1.3 | 102.8 | 14.0 | 8.3 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC502
VC_{diff}: Difference in volumetric capacity versus CFC502

It can be seen from Table 6 that refrigerant mixtures of Examples B1 through B6 in accordance with the present invention exhibit higher coefficients of performance (COP) and similar volumetric capacities as compared to conventional CFC502 or R404A. Considering that a variety of currently commercially available refrigerant mixtures have a gliding temperature difference of less than 7° C., the above-mentioned refrigerant mixtures have no problem associated with use thereof due to the gliding temperature difference below 7° C. In addition, refrigerant mixtures of Examples B1 through B6 have also a compressor discharge temperature similar to CFC502, thus having no problem associated with use thereof.

All refrigerant mixtures of Examples B1 through B6 have an ozone depletion potential (ODP) of 0.0, causing no ozonosphere depletion, and therefore, are also far more environmentally friendly than CFC502. Further, since R404A, an alternative refrigerant to CFC502, exhibits a high global warming potential (GWP) and therefore use thereof is regulated pursuant to the Kyoto Protocol, preparation of the refrigerant mixture utilizing propylene and propane as main ingredients reduces an amount of HFC to be used, thereby alleviating global warming.

For reference, refrigerants having other compositions outside the composition range of the above-mentioned Examples in accordance with the present invention suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples B1 through B3

As shown in Examples B1, B2 and B3 in accordance with the present invention, a content of R125 is preferably less than 30% by weight as an increased content of R125 in the refrigerant mixture undesirably leads to an increase in a gliding temperature difference. In addition, as a content of R1270 in the refrigerant mixture increases, a volumetric capacity also tends to increase. Therefore, in order to ensure that the refrigerant mixture has a volumetric capacity similar to that of a conventional refrigerant, it is preferred that a content of R1270 in the refrigerant mixture does not exceed 20% by weight. As shown in Examples B1 and B2 in accordance with the present invention, an increased content of R290 leads to a decrease in a volumetric capacity of the refrigerant mixture. Therefore, in order to ensure that the refrigerant mixture has a suitable volumetric capacity, a content of R290 is preferably in the range of 60 to 85% by weight.

That is, the refrigerant mixture can achieve a gliding temperature difference of less than 6.5 when the content of R125 is less than 30% by weight. In particular, when the content of R125 is less than 10% by weight, the gliding temperature difference does not exceed 3° C. Further, since vapor pressure of R1270 is higher than R290, it is possible to obtain a volumetric capacity similar to that of a conventional refrigerant when the content of R1270 is in the range of 1 to 20% by weight and the content of R290 is in the range of 60 to 85% by weight.

### Examples B4 through B6

As shown in Examples B4, B5 and B6 in accordance with the present invention, where a content of R143a in the refrigerant mixture exceeds 20% by weight, a volumetric capacity thereof becomes greater than that of the conventional refrigerant, thus requiring replacement of the compressor. Therefore, the content of R143a is preferably less than 20% by weight. This preferred range of R143a may be confirmed from Examples B4 and B5 that a volumetric capacity is increased from 805 to 927 when the composition ratio of R1270 is constant and the content of R143a is increased from 5% by weight to 20% by weight. In addition, this fact may be confirmed from Examples B4 and B6 that a volumetric capacity is increased from 884 to 927 when the composition ratio of R290 is constant and the content of R143a is increased from 10% by weight to 20% by weight.

As shown in Examples B5 and B6 in accordance with the present invention, where a content of R143a in the refrigerant mixture is almost the same and the content of R1270 is increased from 10% by weight to 20% by weight, the volumetric capacity is increased from 805 to 884. Consequently, increased content of R1270 leads to an increased volumetric capacity. As such, the composition ratio of R1270 should not exceed 20% by weight, in order to achieve the volumetric capacity of the refrigerant mixture comparable to that of the conventional refrigerant.

Hereinafter, a refrigerant mixture for substituting R502 and R22 in accordance with a third embodiment of the present invention and construction of a refrigeration system using the same will be described in more detail.

The present invention relates to a refrigerant mixture comprising a selective combination of propylene, propane, R152a and dimethylether (hereinafter, referred to as “DME” and isobutane, as materials that can be used as a refrigerant (hereinafter, referred to as “R”) in vapor compression refrigerators/air conditioners, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, referred to as R22 or HCFC22) which has been widely used in household air conditioners and commercial air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC502 and HCFC22 without significant modification of the existing compressor.

More particularly, the present invention relates to a refrigerant mixture comprising a selective combination of R1270 (propylene), R290 (propane), R152a (1,1-difluoroethane), RE170 (dimethylether, DME) and R600a (isobutane), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC502 or HCFC22.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a selective combination of natural refrigerants R1270 (propylene), R290 (propane), R152a (1,1-difluoroethane), RE170 (dimethylether, DME) and R600a (isobutane), which enables replacement of conventional refrigerants.

Table 7 below shows the results of comparison on coefficients of performance (COP) between the refrigerant mixtures of the present invention and conventional refrigerants, calculated using a computer interpretation program via application of working conditions of the refrigerator/air conditioner utilizing conventional CFC502. Table 8 below shows the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 7
Comparison of performance between CFC502 and the alternative refrigerant mixtures

| | Composition (wt %) | | | | | | | GTD | | COP_{diff} | VC_{diff} |
|---|---|---|---|---|---|---|---|---|---|---|---|
| Refrigerants | R1270 | R290 | R152a | RE170 | R600a | COP | VC(kJ/m³) | (° C.) | T_{dis}(° C.) | (%) | (%) |
| CFC502 | | | | | | 1.07 | 816 | 0.2 | 102.7 | | |
| R404A | | | | | | 0.99 | 807 | 0.7 | 94.7 | −7.5 | −1.1 |
| Ex. C1 | 60 | | 40 | | | 1.35 | 999 | 2.6 | 115.9 | 26.2 | 22.4 |
| Ex. C2 | 90 | | 10 | | | 1.26 | 1003 | 0.1 | 112.5 | 17.8 | 22.9 |
| Ex. C3 | 5 | 90 | 5 | | | 1.19 | 781 | 0.3 | 101.9 | 11.2 | −4.3 |
| Ex. C4 | 10 | 85 | 5 | | | 1.20 | 802 | 0.5 | 102.3 | 12.1 | −1.7 |
| Ex. C5 | 25 | 60 | 15 | | | 1.26 | 920 | 0.4 | 104.1 | 17.8 | 12.7 |
| Ex. C6 | 50 | | | 50 | | 1.35 | 786 | 6.1 | 121.4 | 26.2 | −3.7 |
| Ex. C7 | 60 | | | 40 | | 1.33 | 842 | 4.2 | 119.2 | 24.3 | 3.2 |
| Ex. C8 | 90 | | | 10 | | 1.26 | 956 | 0.2 | 113.6 | 17.8 | 17.2 |
| Ex. C9 | 10 | 70 | | 20 | | 1.25 | 823 | 0.7 | 104.6 | 16.8 | 0.9 |
| Ex. C10 | 10 | 80 | | 10 | | 1.22 | 802 | 0.4 | 103.1 | 14.0 | −1.7 |
| Ex. C11 | 20 | 70 | | 10 | | 1.23 | 837 | 0.6 | 104.1 | 15.0 | 2.6 |
| Ex. C12 | 70 | 10 | | | 20 | 1.28 | 801 | 6.7 | 109.8 | 19.6 | −1.8 |

TABLE 8
Comparison of performance between HCFC22 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R1270 | R290 | R152a | RE170 | R600a | COP | VC (kJ/m³) | (° C.) | (° C.) | (%) | (%) |
| HCFC22 | | | | | | 2.88 | 3565 | 0.0 | 98.2 | | |
| R407C | | | | | | 2.79 | 3776 | 6.9 | 90.6 | −3.1 | 5.9 |
| Ex. C13 | 50 | | 50 | | | 2.93 | 3799 | 4.7 | 88.5 | 1.7 | 6.6 |
| Ex. C14 | 80 | | 20 | | | 2.73 | 3827 | 0.3 | 86.0 | −5.2 | 7.3 |
| Ex. C15 | 90 | | 10 | | | 2.68 | 3847 | 0.1 | 85.9 | −6.9 | 7.9 |
| Ex. C16 | 20 | 40 | 40 | | | 2.84 | 3823 | 1.6 | 83.5 | −1.4 | 7.2 |
| Ex. C17 | 30 | 30 | 40 | | | 2.84 | 3865 | 2.0 | 83.3 | −1.4 | 8.4 |
| Ex. C18 | 40 | 50 | 10 | | | 2.67 | 3588 | 0.3 | 82.7 | −7.3 | 0.6 |
| Ex. C19 | 50 | 40 | 10 | | | 2.67 | 3651 | 0.2 | 83.3 | −7.3 | 2.4 |
| Ex. C20 | 50 | | | 50 | | 2.94 | 3257 | 6.1 | 89.7 | 2.1 | −8.6 |
| Ex. C21 | 90 | | | 10 | | 2.69 | 3619 | 0.2 | 86.3 | −6.6 | 1.5 |
| Ex. C22 | 10 | 70 | | 20 | | 2.70 | 3286 | 0.7 | 82.1 | −6.2 | −7.8 |
| Ex. C23 | 45 | 40 | | 15 | | 2.70 | 3515 | 0.7 | 83.7 | −6.2 | −1.4 |
| Ex. C24 | 70 | 15 | | 15 | | 2.72 | 3596 | 0.6 | 85.4 | −5.6 | 0.9 |
| Ex. C25 | 50 | 40 | | | 10 | 2.70 | 3304 | 4.2 | 83.1 | −6.2 | −7.3 |
| Ex. C26 | 80 | 15 | | | 5 | 2.67 | 3527 | 2.0 | 84.9 | −7.3 | −1.1 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC502 (Table 7) and versus HCFC22 (Table 8)
VC_{diff}: Difference in volumetric capacity versus CFC502 (Table 7) and versus HCFC22 (Table 8)

It can be seen from Tables 7 and 8 that refrigerant mixtures of Examples C1 through C26 in accordance with the present invention exhibit higher or slightly lower coefficients of performance (COP) and similar volumetric capacities as compared to conventional CFC502, R404A, HCFC22 or R407C. Considering that a variety of currently commercially available refrigerant mixtures have a gliding temperature difference of less than 7° C., the above-mentioned refrigerant mixtures have no problems associated with use thereof due to the gliding temperature difference below 7° C. In addition, refrigerant mixtures of Examples C1 through C26 have also a compressor discharge temperature similar to or slightly higher than CFC502 or HCFC22, thus having no problem associated with use thereof.

All refrigerant mixtures of Examples C1 through C26 have an ozone depletion potential (ODP) of 0.0, causing no ozonosphere depletion, and therefore, are also far more environmentally friendly than CFC502 or HCFC22. Further, since R404A or R407C, an alternative refrigerant to CFC502 and HCFC22, exhibits a high global warming potential (GWP) and therefore use thereof is regulated pursuant to the Kyoto Protocol, preparation of the refrigerant mixture utilizing propylene, propane, R152a, DME and isobutane as main ingredients reduces an amount of HFC to be used, thereby alleviating global warming.

For reference, refrigerants having other compositions outside the composition range of the above-mentioned Examples in accordance with the present invention suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples C1 and C2

As shown in Examples C1 and C2 in accordance with the present invention, when a content of R152a in the refrigerant mixture exceeds 40% by weight, this leads to an excessive increase in a gliding temperature difference. In addition, as a content of R1270 exceeds 90% by weight, this undesirably leads to an excessive increase in volumetric capacity.

### Examples C3 through C5

As shown in Examples C3, C4 and C5 in accordance with the present invention, when a content of R1270 in the refrigerant mixture, alternative to CFC502, exceeds 25% by weight, this leads to a much larger volumetric capacity than a conventional refrigerant since R1270 is a high-vapor pressure material, thus requiring replacement of the compressor designed to be suitable for conventional refrigerants. Meanwhile, when a content of R152a exceeds 15% by weight, this leads to an increased gliding temperature difference and compressor discharge temperature, thereby undesirably imposing a heavy burden on the compressor.

### Examples C6 through C8, and C20 and C21

As shown in Examples C6, C7, C8, C20 and C21 in accordance with the present invention, when a content of RE170 in the refrigerant mixture exceeds 50% by weight, this leads to an excessive increase in a gliding temperature difference of the refrigerant mixture and at the same time, an excessive decrease in the volumetric capacity thereof. Therefore, it is preferred that the content of RE170 does not exceed 50% by weight and at the same time, R1270 is contained in an amount of more than 50% by weight to obtain a suitable volumetric capacity.

### Examples C9 through C11

As shown in Examples C9, C10 and C11 in accordance with the present invention, when a content of RE170 in the refrigerant mixture is in the range of 10 to 20% by weight, a gliding temperature difference is less than 1. In contrast, in Examples C6, C7 and C8 of the present invention, an increased content of RE170 leads to an excessive increase in a gliding temperature difference and thus it is preferred that the content of RE170 in the refrigerant mixture containing R1270 and R290 does not exceed 20% by weight. In addition, an increased content of R1270 leads to an increased volumetric capacity, and thus the content of R1270 should not exceed 20% by weight in order to obtain a volumetric capacity similar to that of a conventional refrigerant.

### Example C12

As shown in Example C12 in accordance with the present invention, when a composition ratio of R600a in the refrigerant mixture composed of R600a, R1270 and R290 is increased, a gliding temperature difference of the refrigerant is also significantly increased. In the refrigerant mixture substituting for CFC502, as shown in Example C12, when the content of R600a exceeds 20% by weight, a gliding temperature difference thereof is undesirably greater than 6.7° C. In addition, even when the content of R1270 and R290 except for R600a is varied, the refrigerant mixture will have an optimal value of volumetric capacity.

### Examples C13 through C15

As shown in Examples C13, C14 and C15 in accordance with the present invention, when a content of R152a in the refrigerant mixture exceeds 50% by weight, a gliding temperature difference is excessively increased. In addition, when a content of R1270 exceeds 90% by weight, a volumetric capacity of the refrigerant mixture is excessively increased and a coefficient of performance (COP) thereof is undesirably decreased.

### Examples C16 through C19

As shown in Examples C16 through C19 in accordance with the present invention, when a content of R152a in the refrigerant mixture exceeds 40% by weight, a gliding temperature difference is increased. As an increased content of R1270 leads to a decreased coefficient of performance (COP), a content of R1270 should not exceed 50% by weight in order to prevent excessive lowering of the coefficient of performance (COP). However, R1270 is preferably contained in an amount of more than 20% by weight such that a volumetric capacity of the refrigerant mixture is not excessively decreased.

### Examples C22 through C24

As shown in Examples C22, C23 and C24 in accordance with the present invention, when a content of RE170 in the refrigerant mixture is in the range of 15 to 20% by weight, a gliding temperature difference is less than 1. In contrast, according to Examples C20 and C21 of the present invention, an increased content of RE170 leads to an excessive increase in a gliding temperature difference and thus it is preferred that the content of RE170 in the refrigerant mixture containing R1270 and R290 does not exceed 20% by weight. In addition, as shown in Examples C22, C23 and C24 of the present invention, an increased content of R1270 leads to an increased volumetric capacity, and a volumetric capacity exhibits a proper value of 3596 when the content of R1270 is 70% by weight. Therefore, it is preferred that the content of R1270 does not exceed 70% by weight in order to contain an optimal amount of R290 and RE170.

### Examples C25 and C26

As shown in Examples C25 and C26 in accordance with the present invention, when a composition ratio of R600a in the refrigerant mixture composed of R600a, R1270 and R290 is increased, a gliding temperature difference of the refrigerant is also significantly increased. Therefore, in the refrigerant mixture substituting for HCFC22, as shown in Example C25, it is preferred that the content of R600a does not exceed 10% by weight. In addition, even when the content of R1270 and R290 except for R600a is varied, the refrigerant mixture will have an optimal value of volumetric capacity.

Hereinafter, a refrigerant mixture for substituting R502 and R22 in accordance with a fourth embodiment of the present invention and construction of a refrigeration system using the same will be described in more detail.

The present invention relates to a refrigerant mixture comprising a selective combination of propylene, R134a, R152a and dimethylether (hereinafter, referred to as “DME”) and isobutane, as materials that can be used as a refrigerant (hereinafter, referred to as “R”) in vapor compression refrigerators/air conditioners, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, also referred to as R22 or HCFC22) which has been widely used in household air conditioners and commercial air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC502 and HCFC22 without significant modification of the existing compressor, and a refrigeration system using the same.

More particularly, the present invention relates to a refrigerant mixture comprising a selective combination of R1270 (propylene), R134a (1,1,1,2-tetrafluoroethane), R152a (1,1-difluoroethane), RE170 (dimethylether, DME) and R600a (isobutane), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC502 or HCFC22.

Table 9 below shows the results of comparison on coefficients of performance (COP) between the refrigerant mixtures of the present invention and conventional refrigerants, calculated using a computer interpretation program via application of working conditions of the refrigerator/air conditioner utilizing conventional CFC502. Table 10 below shows the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 9
Comparison of performance between CFC502 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R1270 | R134a | R152a | RE170 | R600a | COP | VC (kJ/m³) | (° C.) | (° C.) | (%) | (%) |
| CFC502 | | | | | | 1.07 | 816 | 0.2 | 102.7 | | |
| R404A | | | | | | 0.99 | 807 | 0.7 | 94.7 | −7.5 | −1.1 |
| Ex. D1 | 30 | 40 | 30 | | | 1.34 | 805 | 8.1 | 117.0 | 25.2 | −1.3 |
| Ex. D2 | 40 | 40 | 20 | | | 1.32 | 880 | 5.2 | 114.1 | 23.4 | 7.8 |
| Ex. D3 | 40 | 30 | 30 | | | 1.34 | 885 | 5.8 | 116.2 | 25.2 | 8.5 |
| Ex. D4 | 70 | 10 | 20 | | | 1.24 | 972 | 0.7 | 108.1 | 15.9 | 19.1 |
| Ex. D5 | 30 | 50 | | 20 | | 1.32 | 753 | 6.1 | 115.0 | 23.4 | −7.7 |
| Ex. D6 | 50 | 10 | | 40 | | 1.34 | 810 | 5.2 | 119.3 | 25.2 | −0.7 |
| Ex. D7 | 70 | 10 | | 20 | | 1.30 | 915 | 1.4 | 114.7 | 21.5 | 12.1 |
| Ex. D8 | 30 | 60 | | | 10 | 1.30 | 794 | 4.6 | 103.8 | 21.5 | −2.7 |
| Ex. D9 | 40 | 50 | | | 10 | 1.30 | 841 | 4.1 | 104.8 | 21.5 | 3.1 |
| Ex. D10 | 70 | 10 | | | 20 | 1.29 | 811 | 6.7 | 109.8 | 20.6 | −0.6 |
| Ex. D11 | 70 | 20 | | | 10 | 1.28 | 894 | 3.8 | 109.2 | 19.6 | 9.6 |

TABLE 10
Comparison of performance between HCFC22 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R1270 | R134a | R152a | RE170 | R600a | COP | VC (kJ/m³) | (° C.) | (° C.) | (%) | (%) |
| HCFC22 | | | | | | 2.88 | 3565 | 0.0 | 98.2 | | |
| R407C | | | | | | 2.79 | 3776 | 6.9 | 90.6 | −3.1 | 5.9 |
| Ex. D12 | 40 | 40 | 20 | | | 2.83 | 3634 | 5.2 | 86.4 | −1.7 | 1.9 |
| Ex. D13 | 50 | 30 | 20 | | | 2.80 | 3739 | 3.0 | 86.0 | −2.8 | 4.9 |
| Ex. D14 | 60 | 10 | 30 | | | 2.81 | 3833 | 2.1 | 86.5 | −2.4 | 7.5 |
| Ex. D15 | 70 | 10 | 20 | | | 2.75 | 3824 | 0.7 | 85.8 | −4.5 | 7.3 |
| Ex. D16 | 50 | 20 | | 30 | | 2.87 | 3415 | 4.2 | 87.8 | −0.3 | −4.2 |
| Ex. D17 | 80 | 10 | | 10 | | 2.71 | 3638 | 0.3 | 86.0 | −5.9 | 2.0 |
| Ex. D18 | 40 | 50 | | | 10 | 2.78 | 3474 | 4.1 | 82.6 | −3.5 | −2.6 |
| Ex. D19 | 60 | 35 | | | 5 | 2.72 | 3623 | 2.1 | 84.0 | −5.6 | 1.6 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC502 (Table 9) and versus HCFC22 (Table 10)
VC_{diff}: Difference in volumetric capacity versus CFC502 (Table 9) and versus HCFC22 (Table 10)

It can be seen from Tables 9 and 10 that refrigerant mixtures of Examples D1 through D19 in accordance with the present invention exhibit higher or similar coefficients of performance (COP) and similar volumetric capacities as compared to conventional CFC502, R404A, HCFC22 or R407C. A gliding temperature difference of these refrigerant mixtures is usually equal to or lower than 7° C. which is a gliding temperature difference currently commercially available refrigerant mixtures, and therefore have no problem associated with use thereof. In addition, refrigerant mixtures of Examples D1 through D19 have also a compressor discharge temperature similar to CFC502 or HCFC22, thus having no problem associated with use thereof.

All refrigerant mixtures of Examples D1 through C19 have an ozone depletion potential (ODP) of 0.0, causing no ozonosphere depletion, and therefore, are also far more environmentally friendly than CFC502 or HCFC22. Further, since R404A or R407C, an alternative refrigerant to CFC502 and HCFC22, exhibits a high global warming potential (GWP) and therefore use thereof is regulated pursuant to the Kyoto Protocol, preparation of the refrigerant mixture utilizing propylene and other low-GWP refrigerants as main ingredients reduces an amount of HFC to be used, thereby alleviating global warming.

For reference, refrigerants having other compositions outside the composition range of the above-mentioned Examples in accordance with the present invention suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples D1 through D4, and D12 through D15

As shown in Examples D1 through D4, and D12 through D15 in accordance with the present invention, when R1270 is used in an amount of less than 30% by weight, a gliding temperature difference of the refrigerant mixture is unsuitably too large, and when the content of R1270 exceeds 70% by weight, a volumetric capacity is too large. An increased content of R134a leads to a decrease in the volumetric capacity and thus R134a is preferably contained within an amount of 40% by weight in order to prevent an excessive decrease of a volumetric capacity. As vapor pressure of R152a is lower than R1270 and R134a, more than 30% by weight of R152a leads to an excessively decreased volumetric capacity of the refrigerant mixture and an excessively increased gliding temperature difference thereof. In contrast, less than 20% by weight of R152a leads to an increased content of R1270 and R134a, unsuitably resulting in an excessively increased volumetric capacity.

### Examples D5 through D7

As shown in Examples D5, D6 and D7 in accordance with the present invention, when a content of R1270 in the refrigerant mixture is less than 30% by weight, this leads to an excessively decreased volumetric capacity and an excessively increased gliding temperature difference. In contrast, when a content of R1270 is greater than 70% by weight, this unsuitably leads to an excessively increased volumetric capacity. In addition, when a content of R134a is greater than 50% by weight or a content of RE170 is greater than 40% by weight, the volumetric capacity is excessively decreased. Therefore, it is preferred that R134a is contained in an amount of less than 50% by weight and RE170 is contained in an amount of less than 40% by weight. In addition, as a lower content of RE170 and R134a leads to an increased content of R1270 contained in the refrigerant mixture, it is preferred that RE170 or R134a is contained in an amount of more than 20% by weight.

### Examples D8 through D11

As shown in Examples D8 through D11 in accordance with the present invention, when a content of R1270 in the refrigerant mixture is more than 70% by weight, this leads to an excessively increased volumetric capacity of the refrigerant mixture. In contrast, when a content of R1270 is less than 30% by weight, this leads to an excessively decreased volumetric capacity of the refrigerant mixture. R600a is a very low-vapor pressure material and thus more than 20% by weight of R600a unsuitably leads to an excessively increased gliding temperature difference.

### Examples D16 and D17

As shown in Examples D16 and D17 in accordance with the present invention, when contents of R134a and RE170 in the refrigerant mixture are too high, this leads to excessively increased gliding temperature difference and at the same time, an excessively decreased volumetric capacity of the refrigerant mixture. Therefore, a combined composition ratio of R134a and RE170 is preferably less than 50% by weight. In particular, as an increased content of RE170 leads to a sharply decreased volumetric capacity of the refrigerant mixture, it is preferred that the content of RE170 does not exceed 30% by weight.

### Examples D18 and D19

As shown in Examples D18 and D19 in accordance with the present invention, when a small amount of R1270 is contained in the refrigerant mixture, a gliding temperature difference is sharply decreased. Thus, R1270 should be contained in an amount of more than 40% by weight. Meanwhile, as a content of R1270 increases, a coefficient of performance (COP) is decreased. Therefore, in order to maintain a suitable coefficient of performance (COP), the content of R1270 is preferably less than 60% by weight. Where the content of R600a is more than 10% by weight, it is not suitable because the gliding temperature difference is too large and the volumetric capacity is too small.

Hereinafter, a refrigerant mixture for substituting R502 and R22 in accordance with a fifth embodiment of the present invention and construction of a refrigeration system using the same will be described in more detail.

The present invention relates to a refrigerant mixture comprising a selective combination of propylene, R152a, dimethylether (hereinafter, referred to as “DME”) and isobutane, as materials that can be used as a refrigerant (hereinafter, referred to as “R”) in vapor compression refrigerators/air conditioners, and a refrigeration system using the same. More specifically, the present invention relates to a refrigerant mixture capable of substituting R502 (hereinafter, also referred to as CFC502) which has been widely used in freezers for low temperature service and refrigerators for transportation service and monochlorofluoromethane (CHClF₂, hereinafter, referred to as R22 or HCFC22) which has been widely used in household air conditioners and commercial air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC502 and HCFC22 without significant modification of the existing compressor, and a refrigeration system using the same.

More particularly, the present invention relates to a refrigerant mixture comprising a selective combination of R1270 (propylene), R152a (1,1-difluoroethane), RE170 (dimethylether, DME) and R600a (isobutane), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC502 or HCFC22.

Table 11 below shows the results of comparison on coefficients of performance (COP) between the refrigerant mixtures of the present invention and conventional refrigerants, calculated using a computer interpretation program via application of working conditions of the refrigerator/air conditioner utilizing conventional CFC502. Table 12 below shows the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 11
Comparison of performance between CFC502 and the alternative refrigerant mixtures

| | Composition (wt %) | | | | | | GTD | T_{dis} | COP_{diff} | VC_{diff} |
|---|---|---|---|---|---|---|---|---|---|---|
| Refrigerants | R1270 | R152a | RE170 | R600a | COP | VC (kJ/m³) | (° C.) | (° C.) | (%) | (%) |
| CFC502 | | | | | 1.07 | 816 | 0.2 | 102.7 | | |
| R404A | | | | | 0.99 | 807 | 0.7 | 94.7 | −7.5 | −1.1 |
| Ex. E1 | 40 | 30 | 30 | | 1.38 | 809 | 6.0 | 122.2 | 29.0 | −0.9 |
| Ex. E2 | 50 | 20 | 30 | | 1.36 | 852 | 4.7 | 120.1 | 27.1 | 4.4 |
| Ex. E3 | 70 | 20 | 10 | | 1.32 | 974 | 1.2 | 114.8 | 23.4 | 19.4 |
| Ex. E4 | 80 | 10 | 10 | | 1.29 | 973 | 0.5 | 113.9 | 20.6 | 19.2 |
| Ex. E5 | 60 | 20 | | 20 | 1.34 | 835 | 6.3 | 111.0 | 25.2 | 2.3 |
| Ex. E6 | 80 | 10 | | 10 | 1.29 | 919 | 3.5 | 111.7 | 20.6 | 12.6 |
| Ex. E7 | 70 | | 10 | 20 | 1.30 | 797 | 6.4 | 111.3 | 21.5 | −2.3 |
| Ex. E8 | 70 | | 20 | 10 | 1.31 | 854 | 3.9 | 113.1 | 22.4 | 4.7 |
| Ex. E9 | 80 | | 10 | 10 | 1.28 | 880 | 3.3 | 112.3 | | |

TABLE 12
Comparison of performance between HCFC22 and the alternative refrigerant mixtures

| | Composition (wt %) | | | | | | GTD | T_{dis} | COP_{diff} | VC_{diff} |
|---|---|---|---|---|---|---|---|---|---|---|
| Refrigerants | R1270 | R152a | RE170 | R600a | COP | VC (kJ/m³) | (° C.) | (° C.) | (%) | (%) |
| HCFC22 | | | | | 2.88 | 3565 | 0.0 | 98.2 | | |
| R407C | | | | | 2.79 | 3776 | 6.9 | 90.6 | −3.1 | 5.9 |
| Ex. E10 | 60 | 20 | 20 | | 2.87 | 3619 | 2.8 | 87.9 | −0.3 | 1.5 |
| Ex. E11 | 80 | 10 | 10 | | 2.74 | 3697 | 0.5 | 86.5 | −4.9 | 3.7 |
| Ex. E12 | 50 | 20 | | 30 | 2.87 | 3415 | 8.6 | 87.8 | −0.3 | −4.2 |
| Ex. E13 | 60 | 30 | | 10 | 2.88 | 3638 | 3.8 | 86.0 | 0.0 | 2.0 |
| Ex. E14 | 80 | 10 | | 10 | 2.77 | 3549 | 3.5 | 85.8 | −3.8 | −0.4 |
| Ex. E15 | 70 | | 20 | 10 | 2.82 | 3386 | 3.9 | 86.3 | −2.1 | −5.0 |
| Ex. E16 | 90 | | 2 | 5 | 2.70 | 3544 | 1.7 | 86.0 | | |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC502 (Table 11) and versus HCFC22 (Table 12)
VC_{diff}: Difference in volumetric capacity versus CFC502 (Table 11) and versus HCFC22 (Table 12)

It can be seen from Tables 11 and 12 that refrigerant mixtures of Examples E1 through E16 in accordance with the present invention exhibit higher or similar coefficients of performance (COP) and similar volumetric capacities as compared to conventional CFC502, R404A, HCFC22 or R407C. A gliding temperature difference of these refrigerant mixtures is usually equal to or lower than 7° C. which is a gliding temperature difference of currently commercially available refrigerant mixtures, and therefore have no problem associated with use thereof. In addition, refrigerant mixtures of Examples E1 through E16 have also a compressor discharge temperature similar to CFC502 or HCFC22, thus having no problem associated with use thereof.

All refrigerant mixtures of Examples E1 through E16 have an ozone depletion potential (ODP) of 0.0, causing no ozonosphere depletion, and therefore, are also far more environmentally friendly than CFC502 or HCFC22. Further, since R404A or R407C, an alternative refrigerant to CFC502 and HCFC22, exhibits a high global warming potential (GWP) and therefore use thereof is regulated pursuant to the Kyoto Protocol, preparation of the refrigerant mixture utilizing propylene and other low-GWP refrigerants as main ingredients reduces an amount of HFC to be used, thereby alleviating global warming.

For reference, refrigerants having other compositions outside the composition range of the above-mentioned Examples in accordance with the present invention suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples E1 through E4

As shown in Examples E1 through E4 in accordance with the present invention, when R1270 is contained in an amount of less than 40% by weight, a gliding temperature difference of the refrigerant mixture is undesirably increased to 6° C. or higher.

If the content of R1270 in the refrigerant mixture is less than 40% by weight, a gliding temperature difference is increased to 6° C. or higher and at the same time, a volumetric capacity is too small. In contrast, if the content of R1270 is more than 80% by weight, a volumetric capacity is undesirably too large. As a higher content of R152a leads to an increased gliding temperature difference, the content of R152a is preferably less than 30% by weight.

### Examples E5 and E6

As shown in Examples E5 and E6 in accordance with the present invention, a content of R600a in the refrigerant mixture is preferably less than 20% by weight in terms of a gliding temperature difference. In order to ensure that a difference in a volumetric capacity between the refrigerant mixtures of Examples E5 and E6 and conventional refrigerants is within the range of 10%, a content of R1270 is preferably within the range of 60 to 80% by weight. Upon considering a composition ratio of R1270 and R600a, a content of R152a is preferably less than 20% by weight.

### Examples E7 through E9

As shown in Examples E7, E8 and E9 in accordance with the present invention, when a content of R600a in the refrigerant mixture exceeds 20% by weight, a gliding temperature difference thereof is excessively increased and a volumetric capacity is decreased. Thus, the content of R600a is preferably less than 20% by weight. In addition, when a content of R1270 is too low, a gliding temperature difference of the refrigerant mixture is also excessively increased and a volumetric capacity is decreased, and thus, the content of R1270 is suitably more than 70% by weight. In order to prevent an excessive increase of the volumetric capacity, the content of R1270 is preferably less than 80% by weight.

### Examples E10 and E11

As shown in Examples E10 and E11 in accordance with the present invention, when a content of R1270 in the refrigerant mixture is less than 60% by weight, a gliding temperature difference thereof is increased and at the same time, a volumetric capacity is excessively decreased. In contrast, when the content of R1270 is more than 80% by weight, a volumetric capacity is excessively increased. As a higher content of R152a leads to an increased gliding temperature difference, it is preferred that the content of R152a does not exceed 20% by weight taking into account a composition ratio of R1270.

### Examples E12 through E14

As shown in Example E12 in accordance with the present invention, when a content of R600a in the refrigerant mixture is 30% by weight, a gliding temperature difference thereof is unsuitably very large, i.e., 8.6° C. Therefore, the content of R600a is preferably less than 20% by weight.

As shown in Examples E12, E13 and E14 in accordance with the present invention, when a composition ratio of R600a in the refrigerant mixture is increased, a gliding temperature difference thereof is increased and at the same time, a volumetric capacity is sharply decreased, and thus a content of R600a is preferably less than 10% by weight. When a content of R1270 is less than 60% by weight, a volumetric capacity of the refrigerant mixture is far inferior to that of the conventional refrigerant. Therefore, it is preferred to contain more than 60% by weight of R1270. An increased R152a also leads to an increased gliding temperature difference and thus the content of R152a is preferably less than 30% by weight.

### Examples E15 and E16

As shown in Examples E15 and E16 in accordance with the present invention, when a content of R600a in the refrigerant mixture exceeds 10% by weight, a gliding temperature difference thereof is increased and at the same time, a volumetric capacity is decreased. Thus, the content of R600a is preferably less than 10% by weight. In addition, when a content of R1270 is too low, a gliding temperature difference of the refrigerant mixture is also excessively increased and a volumetric capacity is decreased, and thus, the content of R1270 is suitably more than 70% by weight. Taking into account a composition ratio of RE170 and R600a, the content of R1270 is preferably less than 90% by weight.

Hereinafter, a refrigerant mixture for substituting R22 in accordance with a sixth embodiment of the present invention and construction of a refrigeration system using the same will be described in more detail.

The present invention relates to a refrigerant mixture comprising a selective combination of propane, R134a and R152a, as materials that can be used as a refrigerant (hereinafter, referred to as “R”) in vapor compression refrigerators/air conditioners, and a refrigeration system using the same. More specifically, the present invention relates to a refrigerant mixture capable of substituting monochlorofluoromethane (CHClF₂, hereinafter, referred to as R22 or HCFC22) which has been widely used in household air conditioners and commercial air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to HCFC22 without significant modification of the existing compressor, and a refrigeration system using the same.

More particularly, the present invention relates to a refrigerant mixture comprising a selective combination of R290 (propane), R134a (1,1,1,2-tetrafluoroethane) and R152a (1,1-difluoroethane), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of HCFC22.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a selective combination of R290 (propane), R134a (1,1,1,2-tetrafluoroethane) and R152a (1,1-difluoroethane), which enables replacement of conventional refrigerants.

Tables 13 and 14 below show the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 13
Comparison of performance between HCFC22 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R290 | R134a | R152a | RE170 | R600a | COP | VC (kJ/m³) | (° C.) | (° C.) | (%) | (%) |
| HCFC22 | | | | | | 2.88 | 3565 | 0.0 | 98.2 | | |
| R407C | | | | | | 2.79 | 3776 | 6.9 | 90.6 | −3.1 | 5.9 |
| Ex. F1 | 40 | 60 | | | | 2.76 | 4084 | 3.2 | 78.9 | −4.2 | 14.6 |
| Ex. F2 | 50 | 50 | | | | 2.74 | 3999 | 0.7 | 79.0 | −4.9 | 12.2 |
| Ex. F3 | 80 | 20 | | | | 2.66 | 3437 | 3.1 | 80.5 | −7.6 | −3.6 |
| Ex. F4 | 40 | 20 | 40 | | | 2.91 | 3777 | 5.9 | 83.8 | 1.0 | 5.9 |
| Ex. F5 | 50 | 10 | 40 | | | 2.85 | 3765 | 2.2 | 82.4 | −1.0 | 5.6 |
| Ex. F6 | 60 | 10 | 30 | | | 2.79 | 3713 | 0.7 | 81.3 | −3.1 | 4.2 |

TABLE 14
Comparison of performance between HCFC22 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R290 | R134a | R152a | RE170 | R600a | COP | VC (kJ/m³) | (° C.) | (° C.) | (%) | (%) |
| HCFC22 | | | | | | 2.88 | 3565 | 0.0 | 98.2 | | |
| R407C | | | | | | 2.79 | 3776 | 6.9 | 90.6 | −3.1 | 5.9 |
| Comp. | 40 | | 60 | | | 2.97 | 3669 | 4.9 | 85.8 | 3.1 | 2.9 |
| Ex. 1 | | | | | | | | | | | |
| Comp. | 45 | | 55 | | | 2.93 | 3705 | 3.6 | 84.5 | 1.7 | 3.9 |
| Ex. 2 | | | | | | | | | | | |
| Comp. | 49 | | 51 | | | 2.89 | 3718 | 2.6 | 83.6 | 0.3 | 4.3 |
| Ex. 3 | | | | | | | | | | | |
| Comp. | 60 | | 40 | | | 2.81 | 3677 | 2.0 | 82.0 | −2.4 | 3.1 |
| Ex. 4 | | | | | | | | | | | |
| Comp. | 65 | | 35 | | | 2.77 | 3700 | 1.8 | 81.8 | −3.8 | 3.3 |
| Ex. 5 | | | | | | | | | | | |
| Ex. F7 | 71 | | 29 | | | 2.75 | 3551 | 0.0 | 81.4 | −4.5 | −0.4 |
| Ex. F8 | 75 | | 25 | | | 2.72 | 3490 | 0.0 | 81.3 | −5.6 | −2.1 |
| Ex. F9 | 80 | | 20 | | | 2.69 | 3403 | 0.1 | 81.2 | −6.6 | −4.5 |
| Ex. F10 | 85 | | 15 | | | 2.66 | 3306 | 0.1 | 81.0 | −7.6 | −7.3 |
| Ex. F11 | 90 | | 10 | | | 2.62 | 3200 | 0.2 | 80.8 | −9.0 | −10.2 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus HCFC22
VC_{diff}: Difference in volumetric capacity versus HCFC22

It can be seen from Tables 13 and 14 that refrigerant mixtures of Examples F1 through E11 in accordance with the present invention exhibit higher or similar coefficients of performance (COP) and similar volumetric capacities as compared to conventional HCFC22 or R407C. In addition, a gliding temperature difference of these refrigerant mixtures is usually equal to or lower than 7° C. which is a gliding temperature difference of currently commercially available refrigerant mixtures, and therefore have no problem associated with use thereof. Further, refrigerant mixtures of Examples F1 through F11 have also a compressor discharge temperature lower than HCFC22, thus having no problem associated with use thereof.

All refrigerant mixtures of Examples F1 through F11 have an ozone depletion potential (ODP) of 0.0, causing no ozonosphere depletion, and therefore, are also far more environmentally friendly than HCFC22. Further, since R407C, an alternative refrigerant to HCFC22, exhibits a high global warming potential (GWP) and therefore use thereof is regulated pursuant to the Kyoto Protocol, preparation of the refrigerant mixture utilizing low-GWP refrigerants such as propane and R152a as main ingredients reduces an amount of HFC to be used, thereby alleviating global warming.

For reference, refrigerants having other compositions outside the composition range of the above-mentioned Examples in accordance with the present invention suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples F1 through F3

As shown in Examples F1 through F3 in accordance with the present invention, when a content of R290 in the refrigerant mixture is less than 40% by weight, a gliding temperature difference thereof is increased. In contrast, when the content of R290 exceeds 80% by weight, a volumetric capacity is excessively decreased. In addition, when a content of R134a in the refrigerant mixture exceeds 60% by weight, a gliding temperature difference is increased and a volumetric capacity is excessively increased. In contrast, when the content of R134a is less than 20% by weight, a volumetric capacity is excessively decreased.

### Examples F4 through F6

As shown in Examples F4 through F6 in accordance with the present invention, when a content of R290 in the refrigerant mixture is less than 40% by weight, a gliding temperature difference thereof is excessively increased. In contrast, when the content of R290 in the refrigerant mixture exceeds 60% by weight, a volumetric capacity is decreased as compared to the conventional refrigerants. Therefore, the content of R290 is preferably within the range of 40 to 60% by weight. An increase of R134a also leads to an increased gliding temperature difference and thus the content of R134a is preferably less than 20% by weight.

### Examples F7 through F11

As shown in Examples F7 through F11 in accordance with the present invention, in a refrigerant mixture composed of propane and 1.1-difluoroethane, where a content of propane is in the range of 71 to 90% by weight, a gliding temperature difference of the refrigerant mixture is within a value of 0.2° C. In contrast, a content of propane in the refrigerant mixture is less than 70% by weight, the gliding temperature difference thereof is much further increased. For example, as shown in Comparative Examples 1 through 5, when more than 65% by weight of propane is contained in the refrigerant mixture, the gliding temperature difference thereof becomes 1.8° C. or higher. As a result, the refrigerant mixture composed of propane and 1,1-difluoroethane will have properties of an azeotropic refrigerant mixture, since the gliding temperature difference thereof is within a range of 0.2° C. when the content of propane exceeds 71% by weight. According to the American Society of Heating, Refrigerating and Air-Conditioning Engineers (ASHRAE) which presents the number designation of the refrigerants, azeotropic mixtures are assigned numbers in the 500 series, while non-azeotropic mixtures are assigned numbers in the 400 series, thus representing that they are given totally different treatment from one another in terms of values thereof. Therefore, the refrigerant mixture composed of propane and 1,1-difluoroethane in which the content of propane is more than 71% by weight can be regarded as an azeotropic refrigerant mixture having excellent properties.

Hereinafter, a refrigerant mixture for substituting R12 and R22 in accordance with a seventh embodiment of the present invention and construction of a refrigeration system using the same will be described in more detail.

The present invention relates to a refrigerant mixture comprising a selective combination of propane, 1,1,1,2-tetrafluoroethane, dimethylether (hereinafter, referred to as “DME”) and isobutane, as materials that can be used as a refrigerant (hereinafter, referred to as “R”) in vapor compression refrigerators/air conditioners, and a refrigeration system using the same. More specifically, the present invention relates to a refrigerant mixture capable of substituting dichlorodifluoromethane (CCl₂F₂ hereinafter, referred to as R12 or CFC12) which has been widely used in household refrigerators and vehicle air conditioners and monochlorofluoromethane (CHClF₂, hereinafter, referred to as R22 or HCFC22) which has been widely used in household air conditioners and commercial air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC12 and HCFC22 without significant modification of the existing compressor.

More particularly, the present invention relates to a refrigerant mixture comprising a selective combination of R290 (propane), R134a (1,1,1,2-tetrafluoroethane), RE170 (dimethylether, DME) and R600a (isobutane), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC12 and HCFC22.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a selective combination of R290 (propane), R134a (1,1,1,2-tetrafluoroethane), RE170 (dimethylether, DME) and R600a (isobutane) such that conventional refrigerants can be replaced.

Table 15 below shows the results of comparison on coefficients of performance (COP) between the refrigerant mixtures of the present invention and refrigerant mixture of Comparative Examples, calculated using a computer interpretation program via application of working conditions of the refrigerator/air conditioner utilizing conventional CFC12. Table 12 below shows the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 15
Comparison of performance between CFC12 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R290 | R134a | R152a | RE170 | R600a | COP | VC (kJ/m³) | (° C.) | (° C.) | (%) | (%) |
| CFC12 | | | | | | 1.55 | 809 | 0.0 | 103.4 | | |
| HFC134a | | | | | | 1.50 | 743 | 0.0 | 97.0 | −3.2 | −8.2 |
| Comp. | 10 | 10 | | 80 | | 1.72 | 914 | 6.0 | 112.0 | | |
| Ex. 1 | | | | | | | | | | | |
| Comp. | 5 | 30 | | 65 | | 1.69 | 870 | 4.7 | 111.0 | | |
| Ex. 2 | | | | | | | | | | | |
| Comp. | 5 | 40 | | 55 | | 1.68 | 886 | 5.2 | 109.0 | | |
| Ex. 3 | | | | | | | | | | | |
| Ex. G1 | 5 | 20 | | 75 | | 1.70 | 853 | 4.3 | 112.2 | 9.7 | 5.4 |

TABLE 16
Comparison of performance between HCFC22 and the alternative refrigerant mixtures

| | Composition (wt %) | | | | | | | GTD | T_{dis} | COP_{diff} | VC_{diff} |
|---|---|---|---|---|---|---|---|---|---|---|---|
| Refrigerants | R290 | R134a | R152a | RE170 | R600a | COP | VC (kJ/m³) | (° C.) | (° C.) | (%) | (%) |
| HCFC22 | | | | | | 2.88 | 3565 | 0.0 | 98.2 | | |
| R407C | | | | | | 2.79 | 3776 | 6.9 | 90.6 | −3.1 | 5.9 |
| Ex. G2 | 50 | | | 50 | | 2.89 | 3194 | 3.6 | 85.2 | 0.3 | −10.4 |
| Ex. G3 | 60 | | | 40 | | 2.82 | 3241 | 2.1 | 83.6 | −2.1 | −9.1 |
| Ex. G4 | 80 | | | 20 | | 2.68 | 3188 | 1.0 | 80.9 | −6.9 | −10.6 |
| Ex. G5 | 30 | 50 | | 20 | | 2.92 | 3609 | 6.3 | 83.7 | 1.4 | 1.2 |
| Ex. G6 | 50 | 20 | | 30 | | 2.85 | 3455 | 3.3 | 83.0 | −1.0 | −3.1 |
| Ex. G7 | 70 | 25 | | 5 | | 2.71 | 3638 | 2.5 | 80.3 | −5.9 | 2.0 |
| Ex. G8 | 80 | 10 | | 10 | | 2.67 | 3304 | 1.5 | 80.9 | −7.3 | −7.3 |
| Ex. G9 | 40 | 55 | | | 5 | 2.81 | 3897 | 3.5 | 79.3 | −2.4 | 9.3 |
| Ex. G10 | 50 | 40 | | | 10 | 2.83 | 3592 | 7.1 | 80.7 | −1.7 | 0.8 |
| Ex. G11 | 70 | 20 | | | 10 | 2.74 | 3248 | 7.1 | 81.2 | −4.9 | −8.9 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC12 (Table 15) and versus HCFC22 (Table 16)
VC_{diff}: Difference in volumetric capacity versus CFC12 (Table 15) and versus HCFC22 (Table 16)

It can be seen from Tables 15 and 16 that refrigerant mixtures of Examples G1 through G11 in accordance with the present invention exhibit coefficients of performance (COP) and volumetric capacities similar to conventional CFC12, R134a, HCFC22 or R407C. In addition, a gliding temperature difference of these refrigerant mixtures is usually equal to or lower than 7° C. which is a gliding temperature difference of currently commercially available refrigerant mixtures, and therefore have no problem associated with use thereof. Further, refrigerant mixtures of Examples G1 through G11 have also a compressor discharge temperature similar to CFC12 or HCFC22, thus having no problem associated with use thereof.

All refrigerant mixtures of Examples G1 through G11 have an ozone depletion potential (ODP) of 0.0, causing no ozonosphere depletion, and therefore, are also far more environmentally friendly than CFC12 or HCFC22. Further, since R134a or R407C, an alternative refrigerant to CFC12 and HCFC22, exhibits a high global warming potential (GWP) and therefore use thereof is regulated pursuant to the Kyoto Protocol, preparation of the refrigerant mixture utilizing low-GWP refrigerants such as propane, DME and isobutane as main ingredients reduces an amount of HFC to be used, thereby alleviating global warming.

For reference, refrigerants having other compositions outside the composition range of the above-mentioned Examples suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples G1, and Comparative Examples 1 through 3

As shown in Example G1 in accordance with the present invention and Comparative Examples 1 through 3, in the refrigerant mixtures substituting for R12, when the content of R290 reaches to 10% by weight, a volumetric capacity of the refrigerant mixture is excessively increased and a gliding temperature difference thereof is also increased. Therefore, the content of R290 is preferably less than 10% by weight. In addition, when the content of R134a is increased while the content of R290 is constant, the gliding temperature difference of the refrigerant mixture is also increased. Therefore, the content of R134a is preferably less than 20% by weight. In a conclusion, as the content of RE170 is increased, gliding temperature difference of the refrigerant mixture is lowered, while the compressor discharge temperature is increased. Therefore, the content of RE170 is preferably in the range of 60 to 80% by weight.

### Examples G2 through 4

As shown in Examples G2 through G4 in accordance with the present invention, when the content of R290 in the refrigerant mixture is increased, a gliding temperature difference thereof is decreased, but a coefficient of performance (COP) is also decreased. Therefore, the content of R290 in the refrigerant mixture is preferably in the range of 50 to 80% by weight. Meanwhile, as the content of RE170 is decreased, gliding temperature difference of the refrigerant mixture is decreased but the coefficient of performance (COP) is also decreased. Therefore, the content of RE170 in the refrigerant mixture is preferably in the range of 20 to 50% by weight.

### Examples G5 through 8

As shown in Examples G5 through G8 in accordance with the present invention, a lower content of R290 in the refrigerant mixture leads to an increased gliding temperature difference. Therefore, if the content of R290 is less than 30% by weight, it is undesirable that the gliding temperature difference of the refrigerant mixture is excessively increased. However, as a higher content of R290 leads to a lower coefficient of performance (COP), it is preferred that the content of R290 does not exceed 80% by weight. As an increased content of R134a also results in an increased gliding temperature difference, the content of R134a is preferably less than 50% by weight so as to avoid an excessively large gliding temperature difference. According to Examples G6 and G7 in accordance with the present invention, the volumetric capacity of the refrigerant mixture is decreased as the content of RE170 is increased. Therefore, in order to maintain a proper volumetric capacity, it is preferred that the content of RE170 does not exceed 30% by weight.

### Examples G9 through G11

As shown in Examples G9 through G11 in accordance with the present invention, a gliding temperature difference of the refrigerant mixture is sharply increased as a content of R600a is increased. Therefore, in order to ensure that the gliding temperature difference of the refrigerant mixture does not exceed 7° C., the content of R600a in the refrigerant mixture is preferably less than 10% by weight. When a content of R290 in the refrigerant mixture is increased, the coefficient of performance (COP) and volumetric capacity thereof are decreased. Therefore, in order to maintain the volumetric capacity similar to a convention refrigerant, the content of R290 is preferably in the range of 40 to 70% by weight. As a content of R134a in the refrigerant mixture is higher, the volumetric capacity thereof is increased. Therefore, in order to achieve a proper volumetric capacity, the content of R134a in the refrigerant mixture is preferably in the range of 20 to 55% by weight.

Hereinafter, a refrigerant mixture for substituting R12 and R22 in accordance with an eighth embodiment of the present invention and construction of a refrigeration system using the same will be described in more detail.

The present invention relates to a refrigerant mixture comprising a selective combination of propane, 1,1-difluoroethane, dimethylether (hereinafter, referred to as “DME”) and isobutane, as materials that can be used as a refrigerant (hereinafter, referred to as “R”) in vapor compression refrigerators/air conditioners, and a refrigeration system using the same. More specifically, the present invention relates to a refrigerant mixture capable of substituting dichlorodifluoromethane (CCl₂F₂, hereinafter, referred to as R12 or CFC12) which has been widely used in household refrigerators and vehicle air conditioners and monochlorofluoromethane (CHClF₂, hereinafter, referred to as R22 or HCFC22) which has been widely used in household air conditioners and commercial air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC12 and HCFC22 without significant modification of the existing compressor, and a refrigeration system using the same.

More particularly, the present invention relates to a refrigerant mixture comprising a selective combination of R290 (propane), R152a (1,1-difluoroethane), RE170 (dimethylether, DME) and R600a (isobutane), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC12 and HCFC22.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a selective combination of R290 (propane), R152a (1,1-difluoroethane), RE170 (dimethylether, DME) and R600a (isobutane) such that conventional refrigerants can be replaced.

Table 17 below shows the results of comparison on coefficients of performance (COP) between the refrigerant mixtures of the present invention and refrigerant mixtures of Comparative Examples, calculated using a computer interpretation program via application of working conditions of the refrigerator/air conditioner utilizing conventional CFC12. Table 18 below shows the results of comparison on coefficients of performance (COP) between the refrigerant mixtures of the present invention and conventional refrigerants, calculated using a computer interpretation program via application of working conditions of the refrigerator/air conditioner utilizing conventional HCFC22.

TABLE 17
Comparison of performance between CFC12 and the alternative refrigerant mixtures

| | Composition (wt %) | | | | | | GTD | | COP_{diff} | VC_{diff} |
|---|---|---|---|---|---|---|---|---|---|---|
| Refrigerants | R290 | R152a | RE170 | R600a | COP | VC (kJ/m³) | (° C.) | T_{dis} (° C.) | (%) | (%) |
| CFC12 | | | | | 1.55 | 809 | 0.0 | 103.4 | | |
| HFC134a | | | | | 1.50 | 743 | 0.0 | 97.0 | −3.2 | −8.2 |
| Comp. | 10 | 80 | 10 | | 1.77 | 1006 | 7.2 | 114.0 | | |
| Ex. 1 | | | | | | | | | | |
| Comp. | 10 | 70 | 20 | | 1.76 | 1000 | 6.3 | 113.0 | | |
| Ex. 2 | | | | | | | | | | |
| Ex. H1 | 5 | 27 | 68 | | 1.72 | 861 | 2.9 | 114.8 | 11.0 | 6.4 |
| Ex. H2 | 5 | 47 | 48 | | 1.73 | 881 | 3.1 | 114.9 | 11.6 | 8.9 |
| Ex. H3 | 2 | | 80 | 18 | 1.71 | 836 | 0.8 | 106.3 | 10.3 | 3.3 |
| Comp. | 5 | | 40 | 55 | 1.71 | 755 | 4.7 | 94.0 | | |
| Ex. 3 | | | | | | | | | | |
| Comp. | 5 | | 50 | 45 | 1.72 | 811 | 3.1 | 96.0 | | |
| Ex. 4 | | | | | | | | | | |
| Ex. H4 | 5 | | 60 | 35 | 1.72 | 850 | 1.9 | 98.7 | 11.0 | 5.1 |
| Ex. H5 | 10 | | 50 | 40 | 1.72 | 861 | 3.4 | 96.9 | 11.0 | 6.4 |
| Ex. H6 | 20 | | 40 | 40 | 1.71 | 900 | 5.2 | 96.0 | 10.3 | 5.9 |
| Ex. H7 | 7 | 48 | | 45 | 1.76 | 861 | 4.9 | 94.7 | 13.5 | 6.4 |
| Ex. H8 | 5 | 70 | | 25 | 1.77 | 947 | 2.3 | 100.1 | 14.2 | 17.1 |

TABLE 18
Comparison of performance between HCFC22 and the alternative refrigerant mixtures

| | Composition (wt %) | | | | | | GTD | | COP_{diff} | VC_{diff} |
|---|---|---|---|---|---|---|---|---|---|---|
| Refrigerants | R290 | R152a | RE170 | R600a | COP | VC (kJ/m³) | (° C.) | T_{dis} (° C.) | (%) | (%) |
| HCFC22 | | | | | 2.88 | 3565 | 0.0 | 98.2 | | |
| R407C | | | | | 2.79 | 3776 | 6.9 | 90.6 | −3.1 | 5.9 |
| Ex. H9 | 40 | 50 | 10 | | 2.98 | 3571 | 4.1 | 85.8 | 3.5 | 0.2 |
| Ex. H10 | 50 | 40 | 10 | | 2.89 | 3608 | 2.1 | 83.7 | 0.3 | 1.2 |
| Ex. H11 | 60 | 30 | 10 | | 2.82 | 3563 | 0.7 | 82.4 | −2.1 | −0.1 |
| Ex. H12 | 70 | 20 | 10 | | 2.75 | 3453 | 0.2 | 81.7 | −4.5 | −3.1 |
| Ex. H13 | 70 | 16 | 14 | | 2.75 | 3409 | 0.3 | 81.8 | −4.5 | −4.4 |
| Ex. H14 | 60 | 30 | | 10 | 2.84 | 3352 | 3.4 | 82.1 | −1.4 | −6.0 |
| Ex. H15 | 70 | 20 | | 10 | 2.77 | 3216 | 3.7 | 81.7 | | |
| Ex. H16 | 70 | 27 | | 3 | 2.76 | 3462 | 1.2 | 81.5 | −4.2 | −2.9 |
| Ex. H17 | 80 | 17 | | 3 | 2.70 | 3294 | 1.6 | 81.2 | | |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC12 (Table 17) and versus HCFC22 (Table 18)
VC_{diff}: Difference in volumetric capacity versus CFC12 (Table 17) and versus HCFC22 (Table 18)

It can be seen from Tables 17 and 18 that refrigerant mixtures of Examples H1 through H17 in accordance with the present invention exhibit higher or similar coefficients of performance (COP) and similar volumetric capacities as compared to conventional CFC12, R134a, HCFC22 or R407C. In addition, a gliding temperature difference of these refrigerant mixtures is usually equal to or lower than 7° C. which is a gliding temperature difference of currently commercially available refrigerant mixtures, and therefore have no problem associated with use thereof. Further, refrigerant mixtures of Examples H1 through H17 have also a compressor discharge temperature similar to CFC12 or HCFC22, thus having no problem associated with use thereof.

All refrigerant mixtures of Examples H1 through H17 have an ozone depletion potential (ODP) of 0.0, causing no ozonosphere depletion, and therefore, are also far more environmentally friendly than CFC12 or HCFC22. Further, since R134a or R407C, an alternative refrigerant to CFC12 and HCFC22, exhibits a high global warming potential (GWP) and therefore use thereof is regulated pursuant to the Kyoto Protocol, preparation of the refrigerant mixture utilizing low-GWP refrigerants such as propane, R152a, DME and isobutane as main ingredients reduces an amount of HFC to be used, thereby alleviating global warming.

For reference, refrigerants having other compositions outside the composition range of the above-mentioned Examples suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples H1 and H2, and Comparative Examples 1 and 2

As shown in Examples H1 and H2 in accordance with the present invention and Comparative Examples 1 and 2, when the content of R290 in the refrigerant mixture exceeds 5% by weight, gliding temperature difference thereof is increased and a volumetric capacity is excessively increased. Further, as shown in Examples H1 and H2, when the content of R152a in the refrigerant mixture is increased, the gliding temperature difference and volumetric capacity are increased. Therefore, the content of R152a in the refrigerant mixture is preferably within the range of 25 to 50% by weight. Meanwhile, as the content of RE170 is increased, the gliding temperature difference and volumetric capacity of the refrigerant mixture are decreased. Therefore, in order to reduce the gliding temperature difference and obtain a proper volumetric capacity, the content of RE170 in the refrigerant mixture is preferably within the range of 45 to 75% by weight.

### Examples H3 through H6, and Comparative Examples 3 and 4

As shown in Examples H3 through H6 in accordance with the present invention and Comparative Examples 3 and 4, when the content of R290 in the refrigerant mixture is increased, the gliding temperature difference and volumetric capacity thereof are increased. Therefore, R290 is preferably contained within an amount of 20% by weight. When the content of R600a in the refrigerant mixture is increased, the gliding temperature difference is also increased. Therefore, the content of R600a in the refrigerant mixture is preferably within 40% by weight. However, when the content of RE170 is increased, the compressor discharge temperature is elevated. Therefore, taking into consideration the content of RE170, it is preferred that the content of R600a exceeds 10% by weight. When the content of RE170 in the refrigerant mixture is higher, the gliding temperature difference is decreased but the compressor discharge temperature is elevated. Therefore, the content of RE170 in the refrigerant mixture is preferably within the range of 40 to 80% by weight.

### Examples H7 and H8

As shown in Examples H7 and H8 in accordance with the present invention, when the content of R290 in the refrigerant mixture is increased, the gliding temperature difference thereof is also increased. Therefore, R290 is preferably contained in an amount of less than 10% by weight. When the content of R152a in the refrigerant mixture is increased, the volumetric capacity and compressor discharge temperature are increased. Therefore, in order to achieve the volumetric capacity similar to that of a conventional refrigerant and in order to prevent elevation of a compressor discharge temperature, the content of R152a in the refrigerant mixture is preferably within the range of 45 to 70% by weight. Meanwhile, when the content of R600a in the refrigerant mixture is increased, the gliding temperature difference is increased and at the same time, the volumetric capacity is decreased. Therefore, in order to reduce the gliding temperature difference and in order to obtain a proper volumetric capacity, the content of R600a in the refrigerant mixture is preferably within the range of 25 to 45% by weight.

### Examples H9 through H13

As shown in Examples H9 through H13 in accordance with the present invention, when a content of R290 in the refrigerant mixture exceeds 40% by weight, a higher content of R290 leads to decreased gliding temperature difference and coefficient of performance (COP). Therefore, in order to reduce the gliding temperature difference while simultaneously obtaining a proper coefficient of performance (COP), the content of R290 in the refrigerant mixture is preferably within the range of 40 to 70% by weight. When the content of R152a in the refrigerant mixture is higher or lower than 40% by weight, the volumetric capacity is decreased. Therefore, in order to appropriately maintain the volumetric capacity of the refrigerant mixture, the content of R152a is preferably within the range of 15 to 50% by weight. Meanwhile, when the content of RE170 in the refrigerant mixture is increased, the volumetric capacity and gliding temperature difference are increased. Therefore, it is preferred that the content of RE170 in the refrigerant mixture does not exceed 10% by weight.

### Examples H14 through H17

As shown in Examples H14 through H17 in accordance with the present invention, when the content of R600a in the refrigerant mixture is increased, the volumetric capacity thereof is significantly decreased. Therefore, the content of R600a in the refrigerant mixture is preferably less than 10% by weight. When the content of R290 in the refrigerant mixture is increased, the volumetric capacity thereof is decreased. Therefore, the content of R290 is preferably within the range of 60 to 80% by weight such that the refrigerant mixture has an optimal volumetric capacity. In addition, when the content of R152a is increased, the volumetric capacity of the refrigerant mixture is also increased. Therefore, in order to obtain a proper volumetric capacity, the content of R152a in the refrigerant mixture is preferably within the range of 15 to 35% by weight.

Hereinafter, a refrigerant mixture for substituting R12 in accordance with a ninth embodiment of the present invention and construction of a refrigeration system using the same will be described in more detail.

The present invention relates to a refrigerant mixture comprising a selective combination of R134a, R152a and dimethylether (hereinafter, referred to as “DME”), as materials that can be used as a refrigerant (hereinafter, referred to as “R”) in vapor compression refrigerators/air conditioners, and a refrigeration system using the same. More specifically, the present invention relates to a refrigerant mixture capable of substituting dichlorodifluoromethane (CCl₂F₂, hereinafter, referred to as R12 or CFC 12) which has been widely used in household refrigerators and vehicle air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC12 without significant modification of the existing compressor, and a refrigeration system using the same.

More particularly, the present invention relates to a refrigerant mixture comprising a selective combination of R134a (1,1,1,2-tetrafluoroethane), R152a (1,1-difluoroethane) and RE170 (dimethylether, DME), and a refrigeration system using the same. The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC12.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a selective combination of R134a (1,1,1,2-tetrafluoroethane), R152a (1,1-difluoroethane) and RE170 (dimethylether, DME) such that conventional refrigerants can be replaced.

Table 19 below shows the results of comparison on coefficients of performance (COP) between the refrigerant mixtures of the present invention and conventional refrigerants, calculated using a computer interpretation program via application of working conditions of the refrigerator/air conditioner utilizing conventional CFC12.

TABLE 19
Comparison of performance between CFC12 and the alternative refrigerant mixtures

| | Composition (wt %) | | | | | | GTD | | COP_{diff} | VC_{diff} |
|---|---|---|---|---|---|---|---|---|---|---|
| Refrigerants | R134a | R152a | RE170 | R600a | COP | VC (kJ/m³) | (° C.) | T_{dis} (° C.) | (%) | (%) |
| CFC12 | | | | | 1.55 | 809 | 0.0 | 103.4 | | |
| HFC134a | | | | | 1.50 | 743 | 0.0 | 97.0 | −3.2 | −8.2 |
| Ex. J1 | 10 | 90 | | | 1.67 | 745 | 0.0 | 116.5 | 7.7 | −7.9 |
| Ex. J2 | 40 | 60 | | | 1.63 | 739 | 0.0 | 110.8 | 5.1 | −8.6 |
| Ex. J3 | 60 | 40 | | | 1.59 | 736 | 0.1 | 106.6 | 2.6 | −9.0 |
| Ex. J4 | 10 | 50 | 40 | | 1.69 | 787 | 0.0 | 115.0 | 9.0 | −2.7 |
| Ex. J5 | 10 | 70 | 20 | | 1.73 | 882 | 0.2 | 95.3 | 11.6 | 9.0 |
| Ex. J6 | 20 | 70 | 10 | | 1.71 | 835 | 0.3 | 107.0 | 10.3 | 3.2 |
| Ex. J7 | 40 | 30 | 30 | | 1.65 | 785 | 0.1 | 110.1 | 6.5 | −3.0 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC12
VC_{diff}: Difference in volumetric capacity versus CFC12

It can be seen from Tables 19 that refrigerant mixtures of Examples J1 through J7 in accordance with the present invention exhibit higher or similar coefficients of performance (COP) and similar volumetric capacities as compared to conventional CFC12 or R134a. In addition, a gliding temperature difference of these refrigerant mixtures is usually equal to or lower than 7° C. which is a gliding temperature difference of currently commercially available refrigerant mixtures, and therefore have no problem associated with use thereof. Further, refrigerant mixtures of Examples J1 through J7 have also a compressor discharge temperature similar to CFC12, thus having no problem associated with use thereof.

All refrigerant mixtures of Examples J1 through J7 have an ozone depletion potential (ODP) of 0.0, causing no ozonosphere depletion, and therefore, are also far more environmentally friendly than CFC12. Further, since R134a, an alternative refrigerant to CFC12, exhibits a high global warming potential (GWP) and therefore use thereof is regulated pursuant to the Kyoto Protocol, preparation of the refrigerant mixture utilizing low-GWP refrigerants such as R152a and DME reduces an amount of HFC to be used, thereby alleviating global warming.

For reference, refrigerants having other compositions outside the composition range of the above-mentioned Examples suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples J1 through J3

As shown in Examples J1 through J3 in accordance with the present invention, when the content of R134a in the refrigerant mixture is increased, coefficient of performance (COP) and volumetric capacity thereof are decreased. Therefore, the content of R134a in the refrigerant mixture is preferably less than 60% by weight. Meanwhile, taking into consideration the content of R134a, it is preferred that the content of R152a is more than 60% by weight. Upon considering that the compressor discharge temperature is elevated as the content of R152a in the refrigerant mixture is higher, it is preferred that R152a is contained in a small amount.

### Examples J4 through J7

As shown in Examples J4 through J7 in accordance with the present invention, when the content of R134a in the refrigerant mixture is increased, the coefficient of performance (COP) and volumetric capacity thereof are decreased. Therefore, the content of R134a is preferably less than 40% by weight. In addition, when the content of R152a in the refrigerant mixture is increased, the coefficient of performance (COP) and volumetric capacity thereof are increased. Therefore, in order to ensure that the refrigerant mixture has a suitable volumetric capacity, the content of R152a is preferably in the range of 30 to 70% by weight. Meanwhile, when the content of RE170 is increased, the compressor discharge temperature is also elevated. Therefore, the content of RE170 in the refrigerant mixture is preferably less than 40% by weight.

Hereinafter, a refrigerant mixture for substituting R12 and R134 in accordance with a tenth embodiment of the present invention and construction of a refrigeration system using the same will be described in more detail.

The present invention relates to a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC12 and HFC134a without significant modification of the existing compressor, and a refrigeration system using the same.

More particularly, the present invention relates to a binary near-azeotropic refrigerant mixture composed of R152a (1,1-difluoroethane) and dimethylether (DME). The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC12 and HFC134a.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a mixture of R152a (1,1-difluoroethane) and RE170 (dimethylether, DME) such that conventional CFC12 and HFC134a refrigerants can be replaced. Since R152a and DME refrigerants have similar vapor pressure therebetween, it is possible to obtain desired properties by suitably mixing them. In addition, it can be confirmed from Table 20 below that a gliding temperature difference, one of the most important factors associated with application of the refrigerant mixture, can be maintained below 0.2° C.

Table 20 below summarizes the results of comparison on coefficients of performance (COP) between the alternative refrigerant mixtures proposed by the present inventors and CFC12 as a reference, calculated using a computer interpretation program via application of working conditions of the refrigerator/air conditioner utilizing conventional CFC12 or HFC134a.

TABLE 20
Comparison of performance between CFC12, HFC134a and the alternative refrigerant
mixtures

| | Composition | | | | | | | | |
|---|---|---|---|---|---|---|---|---|---|
| | (wt %) | | | VC | GTD | | COP_{diff} | VC_{diff} | |
| Refrigerants | R152a | DME | COP | (kJ/m³) | (° C.) | T_{dis} (° C.) | (%) | (%) | GWP |
| CFC12 | | | 1.55 | 809 | 0.0 | 103.4 | | | 8.500 |
| HFC134a | | | 1.50 | 743 | 0.0 | 97.0 | −3.2 | −8.2 | 1.300 |
| Ex. K1 | 3 | 97 | 1.68 | 756 | 0.05 | 116.1 | 8.1 | −6.6 | 7.1 |
| Ex. K2 | 5 | 95 | 1.68 | 758 | 0.08 | 116.16 | 8.1 | −6.4 | 9.9 |
| Ex. K3 | 10 | 90 | 1.68 | 763 | 0.13 | 116.13 | 8.3 | −5.8 | 16.7 |
| Ex. K4 | 15 | 85 | 1.68 | 767 | 0.17 | 116.11 | 8.4 | −5.2 | 23.6 |
| Ex. K5 | 20 | 80 | 1.69 | 772 | 0.17 | 116.09 | 8.6 | −4.7 | 30.4 |
| Ex. K6 | 25 | 75 | 1.69 | 775 | 0.16 | 116.09 | 8.8 | −4.2 | 37.3 |
| Ex. K7 | 29 | 71 | 1.69 | 779 | 0.14 | 116.10 | 8.9 | −3.8 | 42.7 |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC12
VC_{diff}: Difference in volumetric capacity versus CFC12
GWP: global warming potential

As described in Table 20, it can be seen that refrigerant mixtures of Examples K1 through K7 in accordance with the present invention exhibit 8% higher coefficients of performance (COP) and 4% lower volumetric capacities as compared to conventional CFC12 or R134a. In addition, a gliding temperature difference of these refrigerant mixtures is less than 0.2° C. which is much lower than 7° C. which is a gliding temperature difference of currently commercially available refrigerant mixtures, and therefore have no problem associated with use thereof. Further, refrigerant mixtures of Examples K1 through K7 have also a compressor discharge temperature about 13° C. higher than CFC12, thus having no problem associated with use thereof.

All refrigerant mixtures of Examples K1 through K7 have an ozone depletion potential (ODP) of 0.0, causing no ozonosphere depletion, and therefore, are also far more environmentally friendly than CFC12 or HFC134a. Further, since HFC134a exhibits a high global warming potential (GWP) and therefore use thereof is regulated pursuant to the Kyoto Protocol, preparation of the refrigerant mixture utilizing low-GWP refrigerants such as R152a and DME as main ingredients reduces an amount of HFC to be used, thereby alleviating global warming.

Meanwhile, an increased composition ratio of R152a in the refrigerant mixture results in several problems. As can be seen from Table 20, a higher content of R152a leads to an increased global warming potential (GWP). When the content of R152a is 29% by weight, the global warming potential (GWP) is increased to 42.7. Currently, all countries around the world, including EU, plan to use only refrigerants having a GWP of 45 to 50 as environmentally friendly alternative refrigerants taking into account a long term view. In fact, all refrigerants used in household refrigerators meet such requirements. Therefore, in order to satisfy conditions of GWP of less than 45, a composition ratio of R152a in the refrigerant mixture composed of R152a and DME is preferably less than 29% by weight. The refrigerant mixtures of Examples K1 through K7 have the composition ratio of R152a of less than 29% by weight in order to satisfy conditions of GWP.

In addition, when a content of R152a is increased, compatibility between refrigerant oil and the refrigerant is lowered. This is because compatibility between DME and the refrigerant oil is much superior. Taking into consideration such facts, a lower composition ratio of R152a in the R152a/DME refrigerant mixture far less causes a problem associated with practical application thereof to products.

The reason why the refrigerant oil is mixed with the refrigerant is to protect a gear of the compressor which is a center of a refrigerator or compressor. The refrigerant oil requires, of course, properties such as good lubricating ability, resistance to high temperatures, and non-solidification at low temperatures.

In order to perform as required, the refrigerator oil should not be chemically reactive even when it is diluted together with the refrigerant, i.e., there should be compatibility between the refrigerant and refrigerant oil. Since DME exhibits better compatibility with the refrigerant oil than R152a, a higher content of DME in the refrigerant mixture is advantageous. Therefore, refrigerant mixtures of Examples K1 through K7 in accordance with the present invention were selected from those in which the content of DME is more than 71% by weight.

Further, in refrigerant mixtures composed of R152a and DME, an increased composition ratio of R152a results in increased production costs of refrigerant mixtures. Unlike DME, R152a is an artificial compound and thus is 4 to 5 times more expensive than DME. Therefore, for propagation of environmentally friendly refrigerant mixtures, there is an absolute need for inexpensive refrigerants. As such, a lower composition ratio of R152a in the refrigerant mixture is advantageous from an economic point of view.

Hereinafter, a refrigerant mixture for substituting R12 in accordance with an eleventh embodiment of the present invention and construction of a refrigeration system using the same will be described in more detail.

The present invention relates to a refrigerant mixture comprising a selective combination of 1,1,1,2-tetrafluoroethane, 1,1-difluoroethane, dimethylether and isobutane, as materials that can be used as a refrigerant (hereinafter, referred to as R) in vapor compression refrigerators/air conditioners, and a refrigeration system using the same. More specifically, the present invention relates to a refrigerant mixture capable of substituting dichlorodifluoromethane (CCl₂F₂) which has been widely used in household refrigerators and vehicle air conditioners, and a refrigeration system using the same.

The object of the present invention is to provide a refrigerant mixture which has an ozone depletion potential (ODP) of 0.0 with no effects on the ozonosphere within the Earth's stratosphere and a lower global warming potential (GWP) than conventional other alternative refrigerants, and at the same time, can be used as the alternative refrigerant to CFC12 without significant modification of the existing compressor, and a refrigeration system using the same.

More particularly, the present invention relates to a refrigerant mixture comprising a selective combination of R134a (1,1,1,2-tetrafluoroethane), R152a (1,1-difluoroethane), RE170 (dimethylether, DME) and R600a (isobutane). The alternative refrigerant mixture proposed in the present invention has an ozone depletion potential (ODP) of 0.0, a relatively low global warming potential (GWP) as compared to conventional other alternative refrigerants, and a coefficient of performance (COP) and volumetric capacity (VC) close to those of CFC12.

Under the criteria that the ozone depletion potential (ODP) of the alternative refrigerant for the refrigerator/air conditioner must be 0.0 and the global warming potential (GWP) thereof should be minimized to the maximum extent possible, the present inventors employed a mixture of R134a (1,1,1,2-tetrafluoroethane), R152a (1,1-difluoroethane), RE170 (dimethylether, DME) and R600a (isobutane) such that conventional refrigerants can be replaced.

Table 21 below shows the results of comparison on coefficients of performance (COP) between the refrigerant mixtures of the present invention and refrigerant mixtures of Comparative Examples, calculated using a computer interpretation program via application of working conditions of the refrigerator/air conditioner utilizing conventional CFC12.

TABLE 21
Comparison of performance between CFC12 and the alternative refrigerant mixture

| | Composition (wt %) | | | | | | GTD | | COP_{diff} | VC_{diff} |
|---|---|---|---|---|---|---|---|---|---|---|
| Refrigerants | R134a | R152a | RE170 | R600a | COP | VC (kJ/m³) | (° C.) | T_{dis} (° C.) | (%) | (%) |
| CFC12 | | | | | 1.55 | 809 | 0.0 | 103.4 | | |
| HFC134a | 100 | | | | 1.50 | 743 | 0.0 | 97.0 | −3.2 | −8.2 |
| Ex. L1 | 10 | | 90 | | 1.67 | 761 | 0.1 | 114.8 | 7.7 | −5.9 |
| Ex. L2 | 70 | | 30 | | 1.61 | 791 | 0.1 | 104.4 | 3.9 | −2.2 |
| Ex. L3 | 90 | | 10 | | 1.54 | 770 | 0.3 | 99.7 | −0.6 | −4.8 |
| Ex. L4 | 10 | | 60 | 30 | 1.72 | 835 | 0.6 | 99.5 | 11.0 | 3.2 |
| Ex. L5 | 10 | | 70 | 20 | 1.71 | 832 | 0.3 | 104.1 | 10.3 | 2.8 |
| Ex. L6 | 20 | | 60 | 20 | 1.71 | 849 | 0.5 | 102.2 | 10.3 | 4.9 |
| Ex. L7 | 20 | | 70 | 10 | 1.69 | 821 | 0.4 | 107.6 | 9.0 | 1.5 |
| Ex. L8 | | 50 | | 50 | 1.75 | 781 | 3.2 | 93.8 | 12.9 | −3.5 |
| Ex. L9 | | 90 | | 10 | 1.73 | 827 | 0.4 | 110.6 | 11.6 | 2.2 |
| Ex. L12 | | 10 | 60 | 30 | 1.72 | 831 | 0.4 | 100.9 | 11.0 | 2.7 |
| Ex. L13 | | 10 | 40 | 50 | 1.73 | 769 | 2.2 | 95.2 | 11.6 | −4.9 |
| Ex. L14 | | 10 | 80 | 10 | 1.71 | 807 | 0.2 | 110.6 | 10.3 | −0.2 |
| Ex. L10 | 60 | | | 40 | 1.74 | 897 | 5.3 | 88.0 | 12.3 | 10.9 |
| Ex. L11 | 70 | | | 30 | 1.70 | 952 | 2.3 | 87.3 | 9.7 | 17.7 |
| Ex. L12 | 90 | | | 10 | 1.60 | 911 | 0.6 | 92.2 | 3.2 | 12.6 |
| Comp. | 10 | | | 90 | 1.50 | 433 | 5.2 | 60.0 | | |
| Ex. 1 | | | | | | | | | | |
| Comp. | 20 | | | 80 | 1.57 | 519 | 8.1 | 63.0 | | |
| Ex. 2 | | | | | | | | | | |
| Comp. | 30 | | | 70 | 1.64 | 619 | 9.2 | 66.0 | | |
| Ex. 3 | | | | | | | | | | |

COP: Coefficient of performance (Total refrigeration effects/Amount of work put in to a compressor)
VC: Volumetric capacity
GTD: Gliding temperature difference
T_{dis}: Compressor discharge temperature
COP_{diff}: Difference in coefficients of performance versus CFC12
VC_{diff}: Difference in volumetric capacity versus CFC12

It can be seen from Tables 21 that refrigerant mixtures of Examples L1 through L15 in accordance with the present invention exhibit higher or similar coefficients of performance (COP) and similar volumetric capacities as compared to conventional CFC12 or R134a. In addition, a gliding temperature difference of these refrigerant mixtures is much lower than 7° C. which is a gliding temperature difference of currently commercially available refrigerant mixtures, and therefore have no problem associated with use thereof. Further, refrigerant mixtures of Examples L1 through L15 have also a compressor discharge temperature similar to CFC12, thus having no problem associated with use thereof.

All refrigerant mixtures of Examples L1 through L15 have an ozone depletion potential (ODP) of 0.0, causing no ozonosphere depletion, and therefore, are also far more environmentally friendly than CFC12. Further, since R134a, an alternative refrigerant to CFC12, exhibits a high global warming potential (GWP) and therefore use thereof is regulated pursuant to the Kyoto Protocol, preparation of the refrigerant mixture utilizing low-GWP refrigerants such as R152a, DME and isobutane reduces an amount of HFC to be used, thereby alleviating global warming.

For reference, refrigerants having other compositions outside the composition range of the above-mentioned Examples suffer from problems such as excessively large gliding temperature differences, excessively low capacity and efficiency, and excessively high discharge temperatures of the compressors, thereby raising problems associated with practical application thereof to refrigerators/air conditioners. Hereinafter, details thereof will be described.

### Examples L1 through L3

As shown in Examples L1 through L3 in accordance with the present invention, refrigerant mixtures composed of R134a and RE170 exhibit suitable coefficients of performance (COP), volumetric capacities and gliding temperature differences over almost all composition ratios of R134a and RE170. However, as a content of RE170 in the refrigerant mixture becomes higher, the compressor discharge temperature thereof is increased. As such, taking into account the compressor discharge temperature, it is preferred that the content of RE170 is smaller.

### Examples L4 through L7

As shown in Examples L4 through L7 in accordance with the present invention, when a content of RE170 in the refrigerant mixture is higher, a compressor discharge temperature is increased and a volumetric capacity is decreased. Therefore, the content of RE170 in the refrigerant mixture is preferably in the range of 60 to 70% by weight. Meanwhile, when a content of R134a is increased, the volumetric capacity of the refrigerant mixture is increased. Therefore, the content of R134a in the refrigerant mixture is preferably less than 20% by weight. In addition, when content of R600a is increased, the volumetric capacity of the refrigerant mixture is increased and the compressor discharge temperature is lowered. Therefore, in order to achieve suitable volumetric capacity and compressor discharge temperature, the content of R600a is preferably in the range of 21 to 30% by weight.

### Examples L8 and L9

As shown in Examples L8 and L9 in accordance with the present invention, in refrigerant mixtures composed of R152a and R600a, when a content of R152a is increased and a content of R600a is decreased, a gliding temperature difference is decreased and a volumetric capacity is increased. Therefore, in order to obtain the volumetric capacity similar to a conventional refrigerant and in order to minimize the gliding temperature difference, it is preferred that R152a is contained in an amount of more than 55% by weight and R600a is contained in an amount of less than 45% by weight.

### Examples L10 through L12

As shown in Examples L10 through L12 in accordance with the present invention, when a content of R600a in the refrigerant mixture is increased, a gliding temperature difference thereof is increased. In addition, a volumetric capacity is decreased, when a content of R600a is above or below 30% by weight. Therefore, taking into account the gliding temperature difference and volumetric capacity, a content of R600a is preferably less than 50% by weight. When a content of RE170 in the refrigerant mixture is above or below 60% by weight, the volumetric capacity is decreased. In addition, as a content of RE170 is increased, the compressor discharge temperature is increased. Therefore, taking into account the compressor discharge temperature and volumetric capacity, a content of RE170 in the refrigerant mixture is preferably in the range of 40 to 80% by weight. As an increased content of R152a leads to increases in the volumetric capacity and compressor discharge temperature, a content of R152a in the refrigerant mixture is preferably less than 10% by weight.

### Examples L13 through L15 and Comparative Examples 1 through 3

As shown in Examples L13 through L15 in accordance with the present invention and Comparative Examples 1 through 3, when a content of R134a in the refrigerant mixture composed of R134a and R600a is decreased and a content of R600a is increased, it is undesirable that a volumetric capacity is excessively decreased and a gliding temperature difference is excessively increased. Therefore, it is preferred that the content of R134a is more than 60% by weight and the content of R600a is less than 40% by weight.

As used herein, the term refrigeration system refers to refrigerators/air conditioners which are used interchangeably throughout the specification of the present invention unless otherwise particularly specified.

### INDUSTRIAL APPLICABILITY

The present invention is of industrial value as a refrigerant which is used in refrigeration systems such as refrigerators and air conditioners and is useful for prevention of depletion of the ozonosphere and global warming.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A refrigerant mixture for a refrigerator/air conditioner, comprising 1 to 99% by weight of R1270 (propylene), less than 98% by weight of R290 (propane) and 1 to 70% by weight of R134a (1,1,1,2-tetrafluoroethane).

2. The refrigerant mixture according to claim 1, wherein a content of R1270 (propylene) is in the range of 1 to 30% by weight, a content of R290 (propane) is in the range of 60 to 80% by weight and a content of R134a (1,1,1,2-tetrafluoroethane) is in the range of 1 to 10% by weight.

3. The refrigerant mixture according to claim 1, wherein a content of R1270 (propylene) is in the range of 40 to 60% by weight, a content of R290 (propane) is in the range of 40 to 60% by weight and a content of R134a (1,1,1,2-tetrafluoroethane) is in the range of 1 to 10% by weight.

4. A refrigerant mixture for a refrigerator/air conditioner, comprising 1 to 54% by weight of R1270 (propylene) and 46 to 99% by weight of R290 (propane).

5. A refrigerant mixture for a refrigerator/air conditioner, comprising 81 to 99% by weight of R1270 (propylene) and 1 to 19% by weight of R290 (propane).

6. A refrigerant mixture for a refrigerator/air conditioner, comprising 1 to 99% by weight of R1270 (propylene) and 1 to 70% by weight of R134a (1,1,1,2-tetrafluoroethane).

7. The refrigerant mixture according to claim 6, wherein a content of R1270 (propylene) is in the range of 30 to 99% by weight and a content of R134a (1,1,1,2-tetrafluoroethane) is in the range of 1 to 70% by weight.

8. The refrigerant mixture according to claim 6, wherein a content of R1270 (propylene) is in the range of 40 to 99% by weight and a content of R134a (1,1,1,2-tetrafluoroethane) is in the range of 1 to 60% by weight.

9. A refrigerant mixture for a refrigerator/air conditioner, comprising 1 to 99% by weight of R1270 (propylene), 1 to 99% by weight of R290 (propane) and 1 to 30% by weight of R125 (pentafluoroethane).

10. The refrigerant mixture according to claim 9, wherein a content of R1270 (propylene) is in the range of 1 to 20% by weight, a content of R290 (propane) is in the range of 60 to 85% by weight and a content of R125 (pentafluoroethane) is in the range of 1 to 30% by weight.

11. A refrigerant mixture for a refrigerator/air conditioner, comprising 1 to 99% by weight of R1270 (propylene), 1 to 99% by weight of R290 (propane) and 1 to 20% by weight of R143a (1,1,1-trifluoroethane).

12. The refrigerant mixture according to claim 11, wherein a content of R1270 is in the range of 1 to 20% by weight, a content of R290 is in the range of 70 to 90% by weight and a content of R143a is in the range of 1 to 20% by weight.

13. A refrigerant mixture for a refrigerator/air conditioner, comprising 1 to 99% by weight of R1270 (propylene), 1 to 98% by weight of R290 (propane) and 1 to 50% by weight of R152a (1,1-difluoroethane).

14. The refrigerant mixture according to claim 13, wherein a content of R1270 (propylene) is in the range of 1 to 25% by weight, a content of R290 (propane) is in the range of 60 to 90% by weight and a content of R152a (1,1-difluoroethane) is in the range of 1 to 15% by weight.

15. The refrigerant mixture according to claim 13, wherein a content of R1270 (propylene) is in the range of 20 to 50% by weight, a content of R290 (propane) is in the range of 30 to 50% by weight and a content of R152a (1,1-difluoroethane) is in the range of 1 to 40% by weight.

16. A refrigerant mixture for a refrigerator/air conditioner, comprising 60 to 90% by weight of R1270 (propylene) and 1 to 40% by weight of R152a (1,1-difluoroethane).

17. A refrigerant mixture for a refrigerator/air conditioner, comprising 50 to 90% by weight of R1270 (propylene) and 1 to 50% by weight of R152a (1,1-difluoroethane).

18. A refrigerant mixture for a refrigerator/air conditioner, comprising 1 to 99% by weight of R1270 (propylene), 1 to 98% by weight of R290 (propane) and 1 to 50% by weight of RE170 (dimethylether).

19. The refrigerant mixture according to claim 18, wherein a content of R1270 (propylene) is in the range of 1 to 20% by weight, a content of R290 (propane) is in the range of 70 to 80% by weight and a content of RE170 (dimethylether) is in the range of 1 to 20% by weight.

20. The refrigerant mixture according to claim 18, wherein a content of R1270 (propylene) is in the range of 1 to 70% by weight, a content of R290 (propane) is in the range of 10 to 70% by weight and a content of RE170 (dimethylether) is in the range of 10 to 20% by weight.

21. A refrigerant mixture for a refrigerator/air conditioner, comprising 50 to 90% by weight of R1270 (propylene) and 1 to 50% by weight of RE170 (dimethylether).

22. A refrigerant mixture for a refrigerator/air conditioner, comprising 1 to 99% by weight of R1270 (propylene), 1 to 98% by weight of R290 (propane) and 1 to 20% by weight of R600a (isobutane).

23. The refrigerant mixture according to claim 22, wherein a content of R1270 (propylene) is in the range of 20 to 70% by weight, a content of R290 (propane) is in the range of 1 to 70% by weight and a content of R600a (isobutane) is in the range of 1 to 20% by weight.

24. The refrigerant mixture according to claim 22, wherein a content of R1270 (propylene) is in the range of 50 to 80% by weight, a content of R290 (propane) is in the range of 10 to 40% by weight and a content of R600a (isobutane) is in the range of 1 to 10% by weight.

25. A refrigerant mixture for a refrigerator/air conditioner, comprising 30 to 70% by weight of R1270 (propylene), 1 to 69% by weight of R134a (1,1,1,2-tetrafluoroethane) and 1 to 69% by weight of R152a (1,1-difluoroethane).

26. The refrigerant mixture according to claim 25, wherein a content of R1270 (propylene) is in the range of 30 to 70% by weight, a content of R134a (1,1,1,2-tetrafluoroethane) is in the range of 1 to 40% by weight, and a content of R152a (1,1-difluoroethane) is in the range of 20 to 30% by weight.

27. A refrigerant mixture for a refrigerator/air conditioner, comprising 30 to 80% by weight of R1270 (propylene), 1 to 69% by weight of R134a (1,1,1,2-tetrafluoroethane) and 1 to 69% by weight of RE170 (dimethylether).

28. The refrigerant mixture according to claim 27, wherein a content of R1270 (propylene) is in the range of 30 to 70% by weight, a content of R134a (1,1,1,2-tetrafluoroethane) is in the range of 1 to 50% by weight, and a content of RE170 (dimethylether) is in the range of 20 to 40% by weight.

29. The refrigerant mixture according to claim 27, wherein a content of R1270 (propylene) is in the range of 50 to 80% by weight, a content of R134a (1,1,1,2-tetrafluoroethane) is in the range of 1 to 20% by weight, and a content of RE170 (dimethylether) is in the range of 1 to 30% by weight.

30. A refrigerant mixture for a refrigerator/air conditioner, comprising 30 to 70% by weight of R1270 (propylene), 1 to 69% by weight of R134a (1,1,1,2-tetrafluoroethane) and 1 to 69% by weight of R600a (isobutane).

31. The refrigerant mixture according to claim 30, wherein a content of R1270 (propylene) is in the range of 30 to 70% by weight, a content of R134a (1,1,1,2-tetrafluoroethane) is in the range of 1 to 60% by weight, and a content of R600a (isobutane) is in the range of 1 to 20% by weight.

32. The refrigerant mixture according to claim 30, wherein a content of R1270 (propylene) is in the range of 40 to 60% by weight, a content of R134a (1,1,1,2-tetrafluoroethane) is in the range of 35 to 50% by weight, and a content of R600a (isobutane) is in the range of 1 to 10% by weight.

33. A refrigerant mixture for a refrigerator/air conditioner, comprising 40 to 99% by weight of R1270 (propylene), 1 to 59% by weight of R152a (1,1-difluoroethane) and 1 to 59% by weight of RE170 (dimethylether).

34. The refrigerant mixture according to claim 33, wherein a content of R1270 (propylene) is in the range of 40 to 80% by weight, a content of R152a (1,1-difluoroethane) is in the range of 1 to 30% by weight, and a content of RE170 (dimethylether) is in the range of 1 to 30% by weight.

35. The refrigerant mixture according to claim 33, wherein a content of R1270 (propylene) is in the range of 60 to 80% by weight, a content of R152a (1,1-difluoroethane) is in the range of 1 to 20% by weight, and a content of RE170 (dimethylether) is in the range of 1 to 20% by weight.

36. A refrigerant mixture for a refrigerator/air conditioner, comprising 1 to 99% by weight of R1270 (propylene), 1 to 99% by weight of R152a (1,1-difluoroethane) and 1 to 20% by weight of R600a (isobutane).

37. The refrigerant mixture according to claim 36, wherein a content of R1270 (propylene) is in the range of 60 to 80% by weight, a content of R152a (1,1-difluoroethane) is in the range of 1 to 20% by weight, and a content of R600a (isobutane) is in the range of 1 to 20% by weight.

38. The refrigerant mixture according to claim 36, wherein a content of R1270 (propylene) is in the range of 60 to 80% by weight, a content of R152a (1,1-difluoroethane) is in the range of 1 to 30% by weight, and a content of R600a (isobutane) is in the range of 1 to 20% by weight.

39. A refrigerant mixture for a refrigerator/air conditioner, comprising 1 to 99% by weight of R1270 (propylene), 1 to 99% by weight of RE170 (dimethylether) and 1 to 20% by weight of R600a (isobutane).

40. The refrigerant mixture according to claim 39, wherein a content of R1270 (propylene) is in the range of 70 to 80% by weight, a content of RE170 (dimethylether) is in the range of 1 to 20% by weight, and a content of R600a (isobutane) is in the range of 1 to 20% by weight.

41. The refrigerant mixture according to claim 39, wherein a content of R1270 (propylene) is in the range of 70 to 90% by weight, a content of RE170 (dimethylether) is in the range of 1 to 20% by weight, and a content of R600a (isobutane) is in the range of 1 to 10% by weight.

42. A refrigerant mixture for a refrigerator/air conditioner, comprising 40 to 99% by weight of R290 (propane), 1 to 60% by weight of R134a (1,1,1,2-tetrafluoroethane) and 1 to 60% by weight of R152a (1,1-difluoroethane).

43. The refrigerant mixture according to claim 42, wherein a content of R290 (propane) is in the range of 40 to 60% by weight, a content of R134a (1,1,1,2-tetrafluoroethane) is in the range of 1 to 20% by weight and a content of R152a (1,1-difluoroethane) is in the range of 30 to 40% by weight.

44. A refrigerant mixture for a refrigerator/air conditioner, comprising 40 to 99% by weight of R290 (propane) and 1 to 60% by weight of R134a (1,1,1,2-tetrafluoroethane).

45. The refrigerant mixture according to claim 44, wherein a content of R290 (propane) is in the range of 40 to 80% by weight and a content of R134a (1,1,1,2-tetrafluoroethane) is in the range of 20 to 60% by weight.

46. A refrigerant mixture for a refrigerator/air conditioner, comprising 71 to 90% by weight of R290 (propane) and 10 to 29% by weight of R152a (1,1-difluoroethane).

47. The refrigerant mixture according to claim 46, wherein a content of R290 (propane) is in the range of 71 to 80% by weight and a content of R152a (1,1-difluoroethane) is in the range of 20 to 29% by weight.

48. A refrigerant mixture for a refrigerator/air conditioner, comprising 30 to 99% by weight of R290 (propane), 1 to 70% by weight of R134a (1,1,1,2-tetrafluoroethane) and 1 to 70% by weight of RE170 (dimethylether).

49. The refrigerant mixture according to claim 48, wherein a content of R290 (propane) is in the range of 30 to 80% by weight, a content of R134a (1,1,1,2-tetrafluoroethane) is in the range of 1 to 50% by weight and a content of RE170 (dimethylether) is in the range of 1 to 30% by weight.

50. A refrigerant mixture for a refrigerator/air conditioner, comprising 1 to 28% by weight of R290 (propane), 1 to 28% by weight of R134a (1,1,1,2-tetrafluoroethane) and 71 to 99% by weight of RE170 (dimethylether).

51. The refrigerant mixture according to claim 50, wherein a content of R290 (propane) is in the range of 1 to 10% by weight, a content of R134a (1,1,1,2-tetrafluoroethane) is in the range of 1 to 20% by weight and a content of RE170 (dimethylether) is in the range of 60 to 80% by weight.

52. A refrigerant mixture for a refrigerator/air conditioner, comprising 30 to 99% by weight of R290 (propane) and 1 to 70% by weight of RE170 (dimethylether).

53. The refrigerant mixture according to claim 52, wherein a content of R290 (propane) is in the range of 50 to 80% by weight and a content of RE170 (dimethylether) is in the range of 20 to 50% by weight.

54. A refrigerant mixture for a refrigerator/air conditioner, comprising 20 to 90% by weight of R290 (propane), 1 to 70% by weight of R134a (1,1,1,2-tetrafluoroethane) and 1 to 10% by weight of R600a (isobutane).

55. The refrigerant mixture according to claim 54, wherein a content of R290 (propane) is in the range of 40 to 70% by weight, a content of R134a (1,1,1,2-tetrafluoroethane) is in the range of 20 to 55% by weight and a content of R600a (isobutane) is in the range of 1 to 10% by weight.

56. A refrigerant mixture for a refrigerator/air conditioner, comprising 1 to 5% by weight of R290 (propane), 1 to 98% by weight of R152a (1,1-difluoroethane) and 1 to 98% by weight of RE170 (dimethylether).

57. The refrigerant mixture according to claim 56, wherein a content of R290 (propane) is in the range of 1 to 5% by weight, a content of R152a (1,1-difluoroethane) is in the range of 25 to 50% by weight and a content of RE170 (dimethylether) is in the range of 45 to 75% by weight.

58. A refrigerant mixture for a refrigerator/air conditioner, comprising 40 to 98% by weight of R290 (propane), 1 to 59% by weight of R152a (1,1-difluoroethane) and 1 to 59% by weight of RE170 (dimethylether).

59. The refrigerant mixture according to claim 58, wherein a content of R290 (propane) is in the range of 40 to 70% by weight, a content of R152a (1,1-difluoroethane) is in the range of 15 to 50% by weight and a content of RE170 (dimethylether) is in the range of 1 to 15% by weight.

60. A refrigerant mixture for a refrigerator/air conditioner, comprising 1 to 98% by weight of R290 (propane), 1 to 98% by weight of R152a (1,1-difluoroethane) and 1 to 45% by weight of R600a (isobutane).

61. The refrigerant mixture according to claim 60, wherein a content of R290 (propane) is in the range of 1 to 10% by weight, a content of R152a (1,1-difluoroethane) is in the range of 45 to 70% by weight and a content of R600a (isobutane) is in the range of 25 to 45% by weight.

62. The refrigerant mixture according to claim 60, wherein a content of R290 (propane) is in the range of 60 to 80% by weight, a content of R152a (1,1-difluoroethane) is in the range of 15 to 35% by weight and a content of R600a (isobutane) is in the range of 1 to 10% by weight.

63. A refrigerant mixture for a refrigerator/air conditioner, comprising 1 to 20% by weight of R290 (propane), 10 to 98% by weight of RE170 (dimethylether) and 1 to 70% by weight of R600a (isobutane).

64. The refrigerant mixture according to claim 63, wherein a content of R290 (propane) is in the range of 1 to 20% by weight, a content of RE170 (dimethylether) is in the range of 40 to 80% by weight and a content of R600a (isobutane) is in the range of 10 to 40% by weight

65. A refrigerant mixture for a refrigerator/air conditioner, comprising 1 to 60% by weight of R134a (1,1,1,2-tetrafluoroethane), 1 to 98% by weight of R152a (1,1-difluoroethane) and 1 to 99% by weight of RE170 (dimethylether).

66. The refrigerant mixture according to claim 65, wherein a content of R134a (1,1,1,2-tetrafluoroethane) is in the range of 1 to 40% by weight, a content of R152a (1,1-difluoroethane) is in the range of 30 to 70% by weight and a content of RE170 (dimethylether) is in the range of 1 to 40% by weight.

67. A refrigerant mixture for a refrigerator/air conditioner, comprising 1 to 60% by weight of R134a (1,1,1,2-tetrafluoroethane) and 1 to 99% by weight of R152a (1,1-difluoroethane).

68. The refrigerant mixture according to claim 67, wherein a content of R134a (1,1,1,2-tetrafluoroethane) is in the range of 1 to 60% by weight and a content of R152a (1,1-difluoroethane) is in the range of 40 to 99% by weight.

69. A refrigerant mixture for a refrigerator/air conditioner, comprising 1 to 99% by weight of R152a (1,1-difluoroethane) and 1 to 99% by weight of RE170 (dimethylether).

70. A binary near-azeotropic refrigerant mixture for a refrigerator/air conditioner, comprising 3 to 29% by weight of R152a (1,1-difluoroethane) and 71 to 97% by weight of RE170 (dimethylether).

71. A refrigerant mixture for a refrigerator/air conditioner, comprising 1 to 78% by weight of R134a (1,1,1,2-tetrafluoroethane), 1 to 78% by weight of RE170 (dimethylether) and 21 to 99% by weight of R600a (isobutane).

72. The refrigerant mixture according to claim 71, wherein a content of R134a (1,1,1,2-tetrafluoroethane) is in the range of 1 to 20% by weight, a content of RE170 (dimethylether) is in the range of 60 to 70% by weight and a content of R600a (isobutane) is in the range of 21 to 30% by weight.

73. A refrigerant mixture for a refrigerator/air conditioner, comprising 1 to 99% by weight of R134a (1,1,1,2-tetrafluoroethane) and 1 to 99% by weight of RE170 (dimethylether).

74. A refrigerant mixture for a refrigerator/air conditioner, comprising 1 to 98% by weight of R152a (1,1-difluoroethane), 1 to 98% by weight of RE170 (dimethylether) and 1 to 50% by weight of R600a (isobutane).

75. The refrigerant mixture according to claim 74, wherein a content of R152a (1,1-difluoroethane) is in the range of 1 to 10% by weight, a content of RE170 (dimethylether) is in the range of 40 to 80% by weight and a content of R600a (isobutane) is in the range of 1 to 50% by weight.

76. A refrigerant mixture for a refrigerator/air conditioner, comprising 55 to 64% by weight of R152a (1,1-difluoroethane) and 36 to 45% by weight of R600a (isobutane), or 76 to 95% by weight of R152a (1,1-difluoroethane) and 5 to 24% by weight of R600a (isobutane).

77. A refrigerant mixture for a refrigerator/air conditioner, comprising 60 to 89% by weight of R134a (1,1,1,2-tetrafluoroethane) and 11 to 40% by weight of R600a (isobutane).

78. A refrigerator/air conditioner, utilizing a refrigerant mixture of any one of claims 1 through 78.
